(19) United States
(12) Patent Application Publication
(10) Pub. No.: US 2018/0184152 A1
(43) Pub. Date: Jun. 28, 2018

(54) DISTRIBUTED WIRELESS AUDIO AND/OR VIDEO TRANSMISSION

(71) Applicant: Vitaly M. Kirkpatrick, (US)

(72) Inventors: Vitaly M. Kirkpatrick, Salt Lake City, UT (US); Andrzej K. Forys, Salt Lake City, UT (US)

(21) Appl. No.: 15/851,665

(22) Filed: Dec. 21, 2017

Related U.S. Application Data
(60) Provisional application No. 62/551,470, filed on Aug. 29, 2017.
(60) Provisional application No. 62/438,541, filed on Dec. 23, 2016.

(51) Int. Cl. H04N 21/439; H04N 21/44; H04N 21/4363; H04N 21/6405; H04N 21/41; H04N 21/431

(52) U.S. Cl. CPC H04N 21/439; H04N 21/44; H04N 21/43637; H04N 21/4312; H04N 21/4126; H04N 21/43635; H04N 21/6405

(57) ABSTRACT

Systems and methods for a wireless distributed audio and/or video system are shown and described. In an example embodiment, a method includes receiving an audio feed related to video content, or audio-only content, identifying a first client device from a plurality of client devices connected to a media distributor via a wireless network, and sending the audio feed to the first client device via the wireless network.

### RELATED APPLICATIONS

To the extent permitted by applicable law, the present application incorporates herein by reference and claims priority to U.S. patent application No. 62/438,541 filed 23 Dec. 2016 and U.S. patent application No. 62/551,470 filed 29 Aug. 2017.

### FIELD

The present disclosure relates to systems, methods, and other technology for providing a distributed wireless audio and/or video transmission.

### BACKGROUND

Technical challenges arise from situations in which multiple people have conflicting interests in the delivery of audio content. In a restaurant, bar, gym, airplane, or other venue which displays multiple movies or television programs on different respective TVs, for example, different patrons may prefer to hear different corresponding audio portions of the movies or programs, or prefer to not be exposed to any of the audio portions.

Current systems that provide an audio feed separate from a display of video content use separate wired audio ports that a user can plug headphones into at a location separate from the display of the video content. One example of this system is found on airplanes, where video content is displayed on a screen viewable by multiple passengers who may access the audio feed by plugging personal headphones into an in-seat console. These distributed audio and/or video systems allow users in public locations to receive a private audio feed of video content at a location separate from the video content. However, the current versions of these distributed audio and/or video systems require expensive and complex audio wiring to hardwire an audio port at a separate location to provide an audio feed in an in-seat console.

Other systems exist that provide an audio feed wirelessly over a Bluetooth® network (mark of Bluetooth SIG, Inc.). In these systems, an audio feed may be transmitted using a Bluetooth transmitter to a Bluetooth receiver and the Bluetooth receiver may provide the audio feed to a speaker. One example of this is a set of Bluetooth headphones that may be connected to a mobile device that transmits the audio feed to the Bluetooth headphones via the Bluetooth transmitter and receiver. However, these systems are limited by the capabilities of Bluetooth, which only allows limited multiple device simultaneous connectivity, has a limited range, and limited data transmission capabilities. Typical consumer devices utilize Class 2 Bluetooth® technology, which have an effective maximum range of about 5 to 10 meters (about 16 to 33 feet).

Other systems exist that provide a wireless distributed audio system. These systems require multiple display devices to be connected to a single audio transmitter and the audio transmitter will provide the received audio feeds over a network to users of mobile devices. One example of this is in public gyms or bars where various televisions are displayed that provide different video content. The different television audio feeds are wired to a sound system transmitter configured to broadcast wireless audio that listeners can receive privately through their mobile device. However, while these complex audio transmitters provide wireless audio, the complex audio transmitters are expensive and require complex audio wiring to connect the various televisions to the audio transmitters. This complex wiring makes these types of systems cost prohibitive everywhere except in some large public venues such as gyms and bars.

Accordingly, it would be advantageous to have a simple, cost effective solution allowing businesses to distribute, and individual consumers to privately access, a specific wireless audio transmission from a group of transmissions in a distributed audio device system.

### SUMMARY

According to one innovative aspect of the subject matter in this disclosure, a method for providing a wireless audio and/or video feed to a client device is shown and described. In some implementations, the method includes receiving an audio feed related to video content, identifying a first client device from a plurality of client devices connected to a media distributor via a wireless network, and sending the audio feed to the first client device via the wireless network.

Other implementations of one or more of these aspects and other aspects described in this document include systems, apparatus, and/or computer programs, including some configured to perform the actions of the methods, encoded on computer storage devices. The above and other implementations are advantageous in a number of respects as articulated throughout this document. Moreover, the language used in the present disclosure has been principally selected for readability and instructional purposes, and not to limit the scope of the subject matter disclosed herein.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description Each innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope. The disclosure is illustrated by way of example, and not by way of limitation in the figures of the accompanying drawings in which like reference numerals are used to refer to similar elements.

FIG. 1 is a block diagram illustrating an example configuration for a wireless distributed audio and/or video system.

FIG. 2 is a block diagram illustrating an example computer system for a media distributor.

FIG. 3 is a block diagram illustrating an example computing device for a client device.

FIG. 4 is a flowchart of an example method for providing a wireless audio and/or video feed to a client device.

FIG. 5 is a graphical representation of another embodiment of a wireless distributed audio and/or video system.

FIG. 6 is a graphical representation of another embodiment of a wireless distributed audio and/or video system.

FIG. 7 is a graphical representation of another embodiment of a wireless distributed audio and/or video system.

FIG. 8 is a graphical representation of another embodiment of a wireless distributed audio and/or video system.

FIG. 9 is a graphical representation of another embodiment of a wireless distributed audio and/or video system.

FIGS. 10 through 13 illustrate example views of a graphical user interface.

FIG. 14 is an example of a graphical user interface icon.

FIG. 15 is another example of a graphical user interface.

FIG. 16 is a graphical representation showing a chart of audio application functionality.

FIG. 17 is a top view (assuming the device shown is oriented accordingly) of a generally oval example of a media distributor.

FIG. 18 is a bottom view of the media distributor in FIG. 17.

FIG. 19 is a front view of the media distributor in FIG. 17.

FIG. 20 is a rear view of the media distributor in FIG. 17.

FIG. 21 is a first side view of the media distributor in FIG. 17.

FIG. 22 is a perspective view of the bottom of the media distributor in FIG. 17.

FIG. 23 is a second side view of the media distributor in FIG. 17.

FIG. 24 is a perspective view of the top of the media distributor in FIG. 17.

FIG. 25 is a top view (assuming the device shown is oriented accordingly) of a generally circular example of a media distributor.

FIG. 26 is a bottom view of the media distributor in FIG. 25.

FIG. 27 is an exploded perspective view showing components of the media distributor in FIG. 17.

FIG. 28 is a block diagram illustrating a computer system having at least one processor, at least one kernel such as an operating system, and at least one memory, which interact with one another, and also illustrating a configured storage medium.

FIG. 29 is a block diagram illustrating an audio distribution device, also referred to as an “audio distributor”.

FIGS. 30 through 33 are flowcharts illustrating steps in some methods for audio management, including audio separation, audio syncing, audio transmission, audio recording, audio metadata usage, and other aspects.

FIG. 34 is a block diagram illustrating load balancing in a distributed audio system in some situations.

### DETAILED DESCRIPTION

### Acronyms and Abbreviations

Some acronyms and abbreviations are defined below. Others may be defined elsewhere herein or require no definition to be understood by one of skill.

ALU: arithmetic and logic unit

API: application program interface

APP: application

CD: compact disc

CPU: central processing unit

DVD: digital versatile disk or digital video disc

FPGA: field-programmable gate array

FPU: floating point processing unit

GPU: graphical processing unit

GUI: graphical user interface

OS: operating system

RAM: random access memory

ROM: read only memory

URL: uniform resource locator

### Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventor asserts and exercises his right to his own lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” may include, for example, one or more servers, motherboards, processing nodes, virtual systems, audio distribution systems, personal computers (portable or not), personal digital assistants, smartphones, smartwatches, smartbands, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on server computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, audio processing, video processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory or virtual memory, and in some configurations both shared and local memories are present.

“Kernels” include operating systems, hypervisors, virtual machines, BIOS code, and similar hardware interface software.

A “virtual machine” is an emulation of a real or hypothetical physical computer system. Each virtual machine is backed by actual physical computing hardware (e.g., processor and memory) and can support execution of at least one operating system or other kernel.

“Code” means processor instructions, data (which includes constants, variables, and data structures), or both instructions and data. “Code” and “software” are used interchangeably herein. Executable code, interpreted code, and firmware are some examples of code.

“Optimize” means to improve, not necessarily to perfect. For example, it may be possible to make further improvements in a program or an algorithm which has been optimized.

“Program” is used broadly herein, to include applications, kernels, drivers, interrupt handlers, firmware, state machines, libraries, and other code written by programmers (who are also referred to as developers) and/or automatically generated.

“Routine” means a function, a procedure, an exception handler, an interrupt handler, or another block of instructions which receives control via a jump and a context save. A context save pushes a return address on a stack or otherwise saves the return address, and may also save register contents to be restored upon return from the routine.

“Service” means a program in a cloud computing environment or another distributed system. A “distributed system” is a system of two or more physically separate digital computing systems operationally connected by one or more networks.

“Video” may include both a sequence of frames and accompanying audio, or video may only include a sequence of frames with minimal or muted or no accompanying audio, depending on context. For example, when transmission of accompanying audio wirelessly to a destination such as a client device is the context, then the video in question is viewed from a distance by the client device's user and the video in question is effectively only include a sequence of frames with minimal or muted or no accompanying audio at their location, e.g., a display device, where the video in question is displayed. When separation of audio from video is the context, however, then the video in question has (at least prior to the audio's separation) both a sequence of frames and accompanying audio, because otherwise the contemplated separation cannot occur.

“IoT” or “Internet of Things” means any networked collection of addressable embedded computing nodes. Such nodes are examples of computer systems as defined herein, but they also have at least two of the following characteristics: (a) no local human-readable display; (b) no local keyboard; (c) the primary source of input is sensors that track sources of non-linguistic data; (d) no local rotational disk storage—RAM chips or ROM chips provide the only local memory; (e) no CD or DVD drive; (f) embedment in a household appliance; (g) embedment in an implanted medical device; (h) embedment in a vehicle; (i) embedment in a process automation control system; or (j) a design focused on one of the following: environmental monitoring, civic infrastructure monitoring, industrial equipment monitoring, energy usage monitoring, human or animal health monitoring, or physical transportation system monitoring. Some embodiments of innovative audio distributors described herein include or function as IoT nodes.

As used herein, “include” allows additional elements (i.e., includes means comprises) unless otherwise stated. “Consists of” means consists essentially of, or consists entirely of. X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Operations such as transmitting data, identifying audio sources, and approving and performing audio data manipulation requests, are understood herein as requiring and providing speed and accuracy that are not obtainable by human mental steps, in addition to their inherently digital nature. This is understood by persons of skill in the art but others may sometimes need to be informed or reminded of that fact.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Linguistically” means by using a natural language or another form of communication which is often employed in face-to-face human-to-human communication. Communicating linguistically includes, for example, speaking, typing, or gesturing with one's fingers, hands, face, and/or body.

Throughout this document, use of the optional plural “(s)”, “(es)”, or “(ies)” means that one or more of the indicated feature is present. For example, “processor(s)” means “one or more processors” or equivalently “at least one processor”.

For the purposes of United States law and practice, at least, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, at least, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by legal construction of claim language by a court or other authority, the means recited in the specification for a given noun or a given verb should be understood to be linked to the claim language and linked together herein by virtue of any of the following: appearance within the same block in a block diagram of the figures, denotation by the same or a similar name, denotation by the same reference numeral. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest with regard to a destination or other subject may involve intervening action by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave outside the scope of patentable subject matter under United States Patent and Trademark Office (USPTO) interpretation of the In re Nuijten case. No claim covers a signal per se in the United States, and any claim interpretation that asserts otherwise is unreasonable on its face. Unless expressly stated otherwise in a claim granted outside the United States, a claim does not cover a signal per se.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

Some embodiments described herein may be viewed in a broader context. For instance, concepts such as audibility, conversion, customization, synchronization, and visibility, may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and methods involving audibility, conversion, customization, synchronization, or visibility are outside the present scope. Accordingly, vagueness, mere abstractness, lack of technical character, and accompanying proof problems are also avoided under a proper understanding of the present disclosure.

The technical character of embodiments described herein will be apparent to one of ordinary skill in the art, and will also be apparent in several ways to a wide range of attentive readers. First, some embodiments address technical activities that are rooted in network, audio, video, or computing technologies, such as providing quality audio output in noisy environments, synchronizing audio and video information in the presence of network delays, or selecting an audio source in response to recipient movement. Second, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein separate audio information from a video stream. Third, technical effects provided by some embodiments include efficient customization of copies of audio information for individual recipients who share a single visual display of a video source that provides the audio information. Fourth, some embodiments include technical adaptations such as a one-to-one media distributor that attaches to a single television mechanically and also digitally or electronically or both. Fifth, technical advantages of some embodiments include reduced cost, easier installation, and improved usability. Other advantages will also be apparent to one of skill from the description provided.

Note Regarding Hyperlinks

Portions of this disclosure may be interpreted as containing URLs, hyperlinks, paths, or other items which might be considered browser-executable codes, e.g., instances of “c:\”. These items are included in the disclosure for their own sake to help describe some embodiments, rather than being included to reference the contents of web sites or other online or cloud items that they identify. Applicants do not intend to have these URLs, hyperlinks, paths, or other such codes be active links. None of these items are intended to serve as an incorporation by reference of material that is located outside this disclosure document. The United States Patent and Trademark Office or other national patent authority will disable execution of these items if necessary when preparing this text to be loaded onto any official web or online database.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 example configuration for a wireless distributed audio and/or video system
101 media distributor
103 display device
105 network
115 client device
117 media application
201 controller
203 audio board
205 audio inputs
207 receiver application
209 processor
220 bus or software communication mechanism
237 memory, e.g., computer-readable storage medium such as RAM or hard disk
241 communication unit
243 data storage
301 audio application
307 display selection module
309 auto switching module
311 audio control module
313 user interface module
400 flowchart of an example method for providing a wireless audio and/or video feed to a client device
402 receive an audio and/or video feed from a display device
404 identify a client device from a plurality of connected client devices
406 send an audio and/or video feed to a client device
501 plug
503 connector generally
701 video content
801 main board
803 multicast group
805 speakers
1000 graphical user interface (GUI)
1001 display device name (may be alphanumeric or other identifier)
1003 command tool, or button etc. for invoking it
1005 advertisement
1101 list of recordings, e.g., in GUI
1103 recordings, e.g., extracted from streamed video content
1201 user instructions displayed in app, e.g., for performing action shown in Figures or discussed in text herein, including for instance how to connect app to a particular display device (achieved by connecting to associated media distributor)
1203 audio indicator icon, e.g., in GUI or app icon on user device
1301 listing of display devices for user to select from
1500 administrative screen in app GUI
1600 chart of audio functionalities available to user through app
1601 connect to a display device audio feed manually
1603 select an audio channel (manually or automatically)
1605 perform stop, start, play, pause, forward, backward, change volume, or similar stream presentation control action(s)
1607 record stream (this is another example of 1605 control)
1609 save audio stream to a smartphone or cloud (this is another example of 1605 control)
1611 interact with an advertisement, e.g., click on or select
1613 make or use a personal audio channel
1615 personal audio channel
1701 media distributor housing
1703 tab to affix display device identifier to media distributor
1705 rubber ring (which includes rubber edge) in housing
1707 region on housing to bear vendor or service provider trademark
1801 projection to insert in hole in display device identifier card to attach identifier card to media distributor
1803 attachment prongs for attaching media distributor to display device
1805 ridges in media distributor housing
1901 media distributor reset
2001 vents in media distributor housing
2601 holes in media distributor housing, shaped to receive screw or bolt or nail head and then slide housing down onto screw or bolt or nail shaft
2603 holes in media distributor housing, shaped to receive zip tie or wire or fishing line or the like
2702 display device identifier
2800 networked or distributed system such as a cloud computing operating environment, also referred to as a network or cloud or IoT or as an operating environment
2802 computer system or device within a larger system
2804 users
2806 peripherals
2814 removable configured computer-readable storage medium
2816 instructions executable with processor
2818 data
2820 kernel software
2822 software tools
2824 application software (“software” may include firmware)
2826 display screen(s)
2828 hardware in addition to processor hardware, memory hardware, display hardware, peripheral hardware, e.g., buses, batteries, power supplies, timing circuits, network interface cards, microphones, cameras, speakers, etc.
2901 audio distributor
2903 analog to digital converter (“ADC”)
2905 digital processing unit
2804 people
2907 access point (may include wireless router)
2909 transmission unit, e.g., network interface
2911 mobile device, e.g., smartphone
2913 tablet
2915 implants
2917 headphones
2919 TV (television)
2921 audio source
2923 recorder, including onboard storage or external storage access or both, and control logic for record, play, rewind, fast forward, naming, etc.
2925 audio source ID

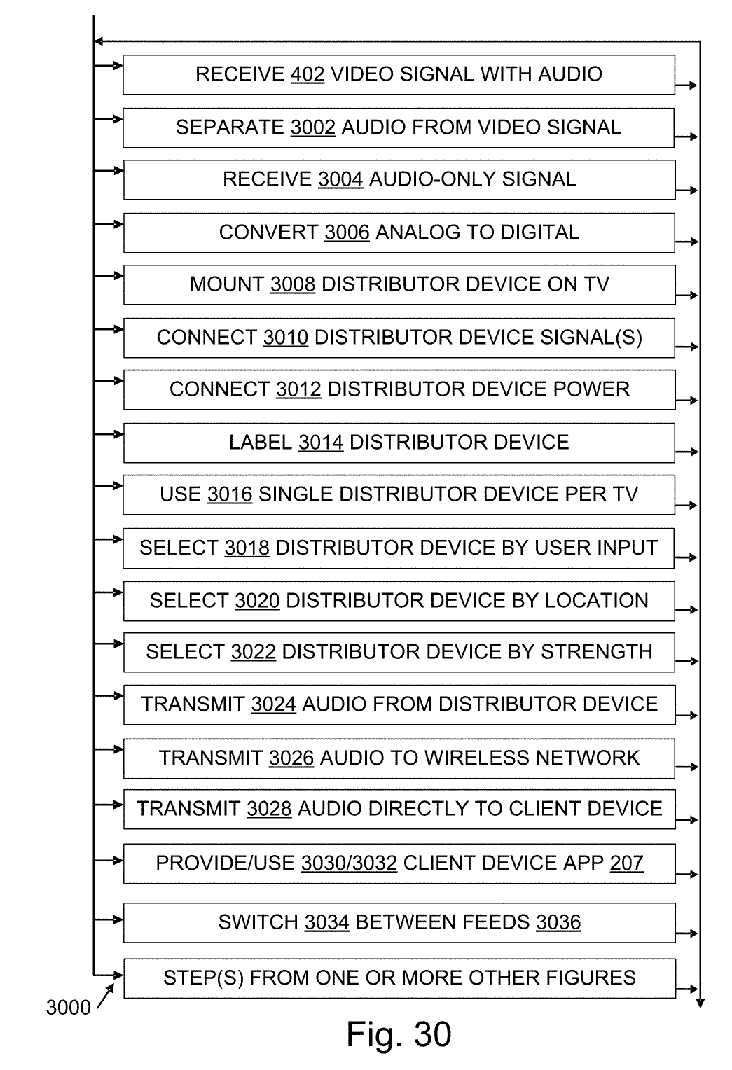

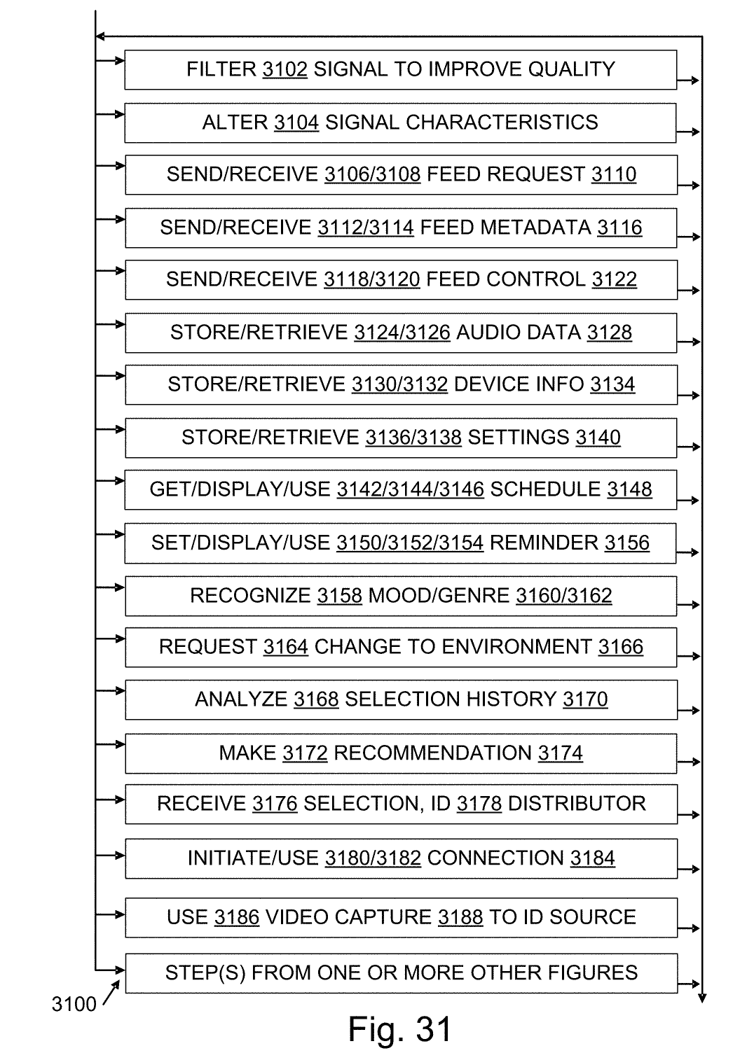

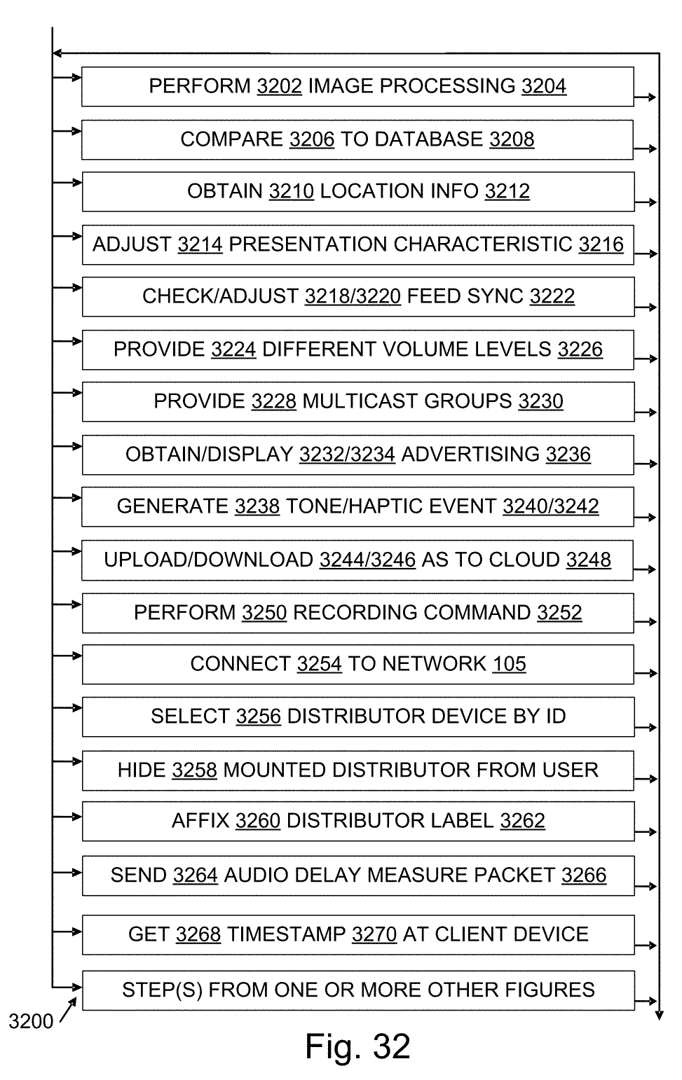

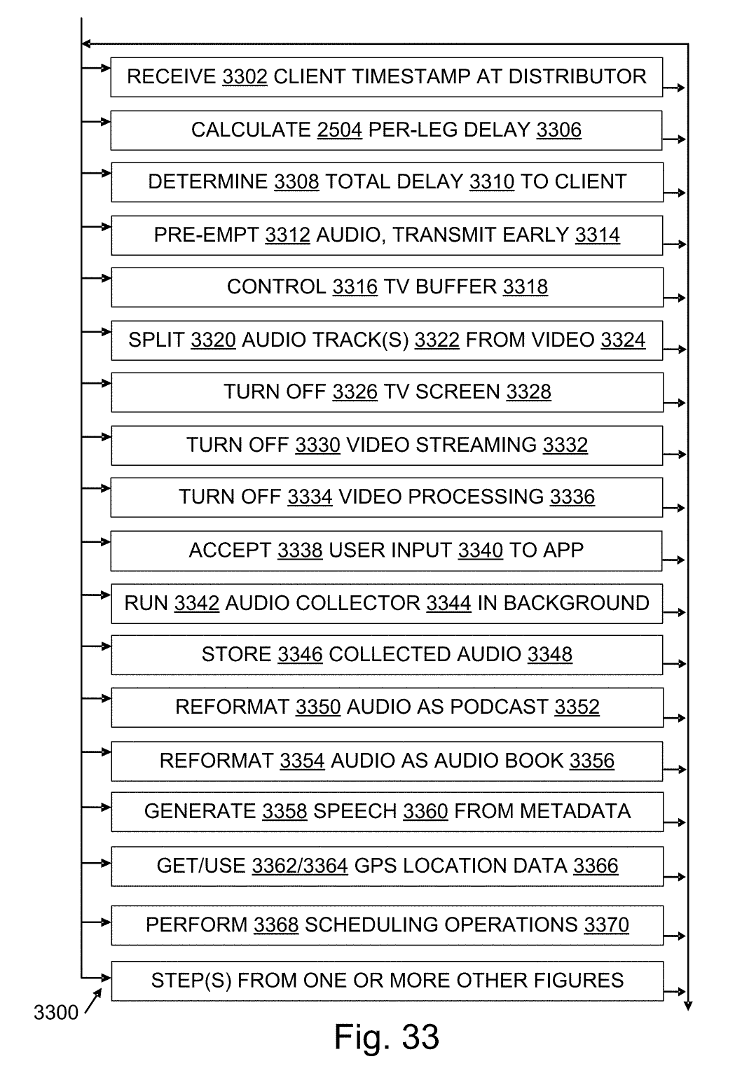

Additional reference numerals are shown in FIGS. 30-33, and hereby incorporated into this list.
3400 mesh network illustrating load balancing in an audio distribution system
3402 load balanced system
3404 load balancer device; may be integrated into media distributor
3406 leader device, e.g., media distributor configured as leader for load balancing
3408 follower device, e.g., media distributor configured as follower for load balancing
3410 array of load balanced devices

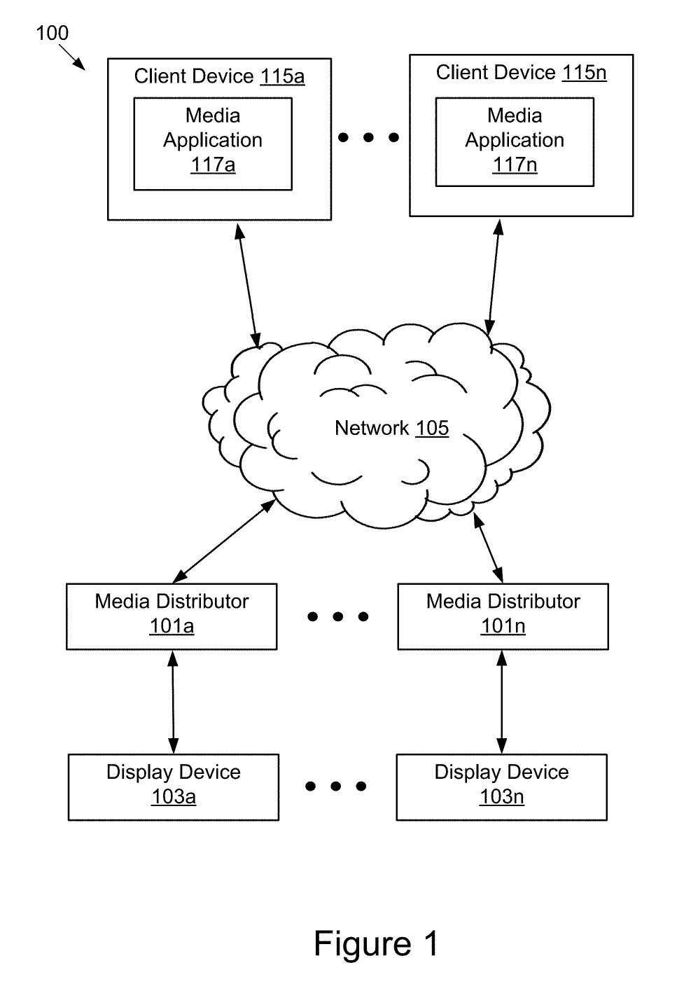

In FIG. 1 and the remaining figures, a letter after a reference number, e.g., “101a,” represents a reference to the element having that particular reference number. A reference number in the text without a following letter, e.g., “101,” represents a general reference to instances of the element bearing that reference number. In the illustrated embodiment, these entities of an example configuration 100 are communicatively coupled via a network 105.

FIG. 1 is a block diagram illustrating an example configuration 100 for a wireless distributed audio and/or video system. A client device 115 may connect using a media application 117 via a network 105 to a media distributor 101 coupled to a display device 103. In some embodiments, the display device 103 includes a display screen (e.g., a television screen, a computer monitor, a projected image, a virtual reality projection, a holographic projection, etc.) that is displaying video content. In some embodiments, the display device 103 may include a processor used to display the video content. The display device 103 may also provide an audio and/or video signal (e.g., the sound associated with the video content, etc.) to the media distributor 101.

In some embodiments, the media distributor 101 receives the audio and/or video signal and provides it via a network 105 (in some cases the network may be a wireless network) to the client device 115. In some embodiments, the client device 115 may be a mobile device (e.g., a cell phone, tablet, etc.) which may include or be coupled (e.g. physically or wirelessly) to an audio output device (not shown), such as a speaker, headphones, a Bluetooth connected speaker, etc., and the user may listen to the audio and/or watch the video feed associated with the video content displayed on display device 103. In some cases, the user may listen to audio even though the associated video is not displayed on display device 103, e.g., because the visual portion of the video is suppressed while the audio plays, or because the video is not currently playing and the audio was recorded, or because the display device is turned off and the audio is extracted from a signal to another device. In some embodiments, audio can be extracted from a cable box or set-top box device, for example, regardless of whether visual images from the signal are also displayed.

In further embodiments, the audio and/or video feed may be a video feed and/or a combination of an audio and video feed. In some embodiments, the client device 115 may include or be or be coupled to a client-side display device (not shown). For example, the client device 115 may be a cell phone or tablet with a display, Bluetooth, an audio jack, built-in speaker, etc.)

For clarity and convenience, example embodiments of the wireless distributed audio and/or video system are described below; however, it should be recognized that the example of a client device 115a of a user going to a gym or bar that has display devices 103a-103n at various locations is merely one example; others exist and are contemplated within the scope of this disclosure.

Also, assume that in the gym or bar each of the display devices 103a-103n are coupled to their own media distributors 101a-101n. As the user sits at a table or exercises at a piece of equipment, the user can access, on the client device 115a, a media application 117a that allows the user to select a media distributor 101n and receive the audio and/or video stream. The selected media distributor 101n corresponds to the video content displayed on the display device 103n. The correspondence between audio and video may be varied, e.g., the audio may be a soundtrack originally provided to the distributor with the video images, or the audio may be a translation of such audio, or the audio may be provided to a user through a speaker on the display device or through a distinct public address system, or some combination of these or other options. In some embodiments, the audio and/or video stream may be provided to the client device via a network 105 including WLAN(s). In further embodiments, the network 105 may include a Bluetooth or radio frequency network. The wireless distributed audio and/or video system described in the example, allows a user to receive an audio and/or video feed using a client device 115 remotely from a display device 103 and further allows a user to quickly switch between different audio and/or video feeds using the media application 117.

In further embodiments, multiple users may simultaneously connect to the same media distributor 101a and receive individual audio and/or video feeds at the separate client devices 115 without interfering with each other. However, in some embodiments client devices may interact with each other, e.g., for chat or messaging or sharing content.

The network 105 can be a conventional type, wired or wireless, and may have numerous different configurations including a star configuration, token ring configuration, or other configurations. Furthermore, the network 105 may include a local area network (LAN), a wide area network (WAN) (e.g., the Internet), and/or other interconnected data paths across which multiple devices may communicate. In some embodiments, the network 105 may be a wireless local area network that connects devices using the IEEE 802.11 standards (e.g., Wi-Fi® implementations). IEEE is the Institute of Electrical and Electronics Engineers. These connected devices may be Wi-Fi compatible devices that connect to the Internet via a wireless LAN access point. In some embodiments, the network 105 may be a WiGig channel (capable in some embodiments of transmitting at 60 Ghz) over longer distances. In some, an IEEE 802.15.4 standard such as Zigbee is used. In some embodiments, the wireless network includes cellular devices and protocols, such as 3G, 4G, 5G, LTE, for example. Some use Sigfox, in the 900 MHz frequency. In short, wireless networks are not limited to 802.11 compliant networks, or to the specific examples listed herein.

In some embodiments, the network 105 may be a peer-to-peer network. The network 105 may also be coupled to or include portions of a telecommunications network for sending data in a variety of different communication protocols. In some embodiments, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. Some use known UDP or TCP port assignments, e.g. port 80 for HTTP, port 443 for HTTPS, and so on. In further embodiments, the network 105 may transmit data via light transmission, such as through fiber optic cables, wireless transmission over distances to light sensors, via satellites, etc. Some embodiments utilize a home-to-home or other peer-to-peer network, such as a home-to-home protocol, or an ad hoc network or user-created network.

Although FIG. 1 illustrates one network 105 coupled to the client devices 115 and the media distributor 101, in practice one or more networks 105 can be connected to these entities. In some embodiments, the display device 103 may also be separately coupled directly to the network 105 instead of, or along with, being coupled to the media distributor 101.

The client device 115 may be a computing device that includes a memory and a processor, for example a laptop computer, a desktop computer, a tablet computer, a mobile telephone (e.g., feature phones, smart phones, etc.), a personal digital assistant (PDA), a mobile email device, a user wearable computing device, TVs, set-top boxes, media streaming devices, portable media players, navigation devices, headphones with a processer (wired or wireless), etc. or any other electronic device capable of accessing a network 105. The client device 115 provides general control and processing for audio and/or video feeds received at the client device 115. In some embodiments, the client device 115 may further include a display for viewing information provided by the media application 117.

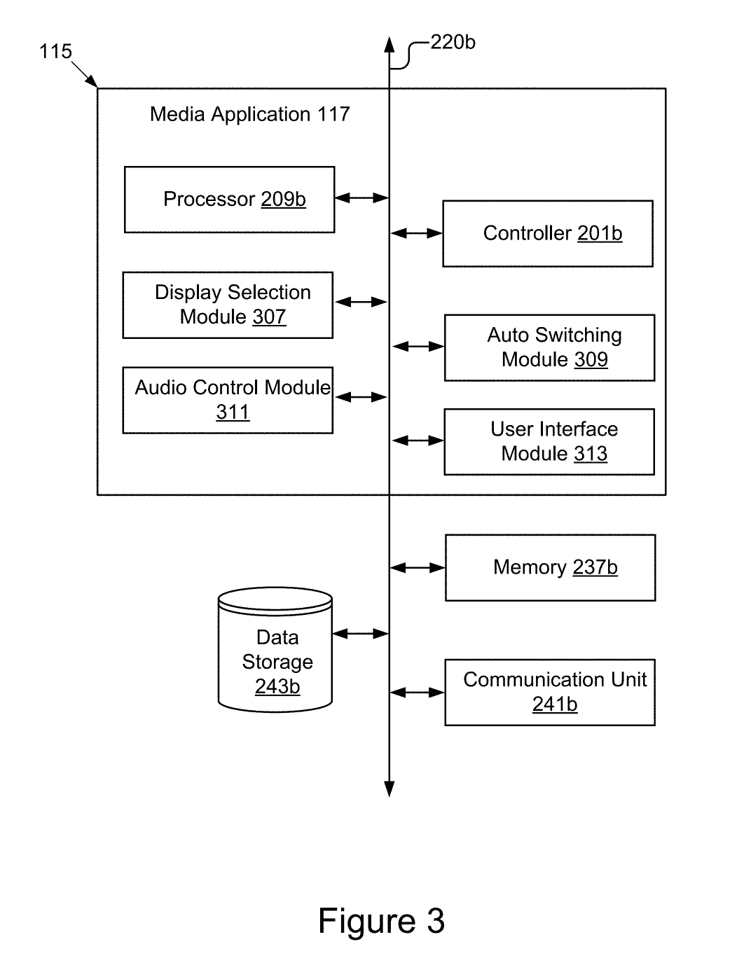

While FIG. 1 illustrates two client devices 115a and 115n, the disclosure applies to a system architecture having one or more client devices 115. In some embodiments, the client device 115 may include a media application 117 configured to provide access and control of the audio and/or video feed received from the network 105. The media application 117 will be discussed in more detail with reference to FIG. 3.

The display device 103 may be a television, computer, monitor, projector, virtual reality headset, or another display device capable of presenting information. In some embodiments, the display device 103 may receive media content via the network 105, a set-top box such as a cable box, a Roku® or other streaming media player (mark of Roku LLC), a media player (VCR, CD, DVD, Blu-Ray, etc.), a personal computer, a server computer, or any other type of device (not shown) connected to the display device 103 and configured to provide a content feed to the display device, including in some embodiments an audio-only content feed.

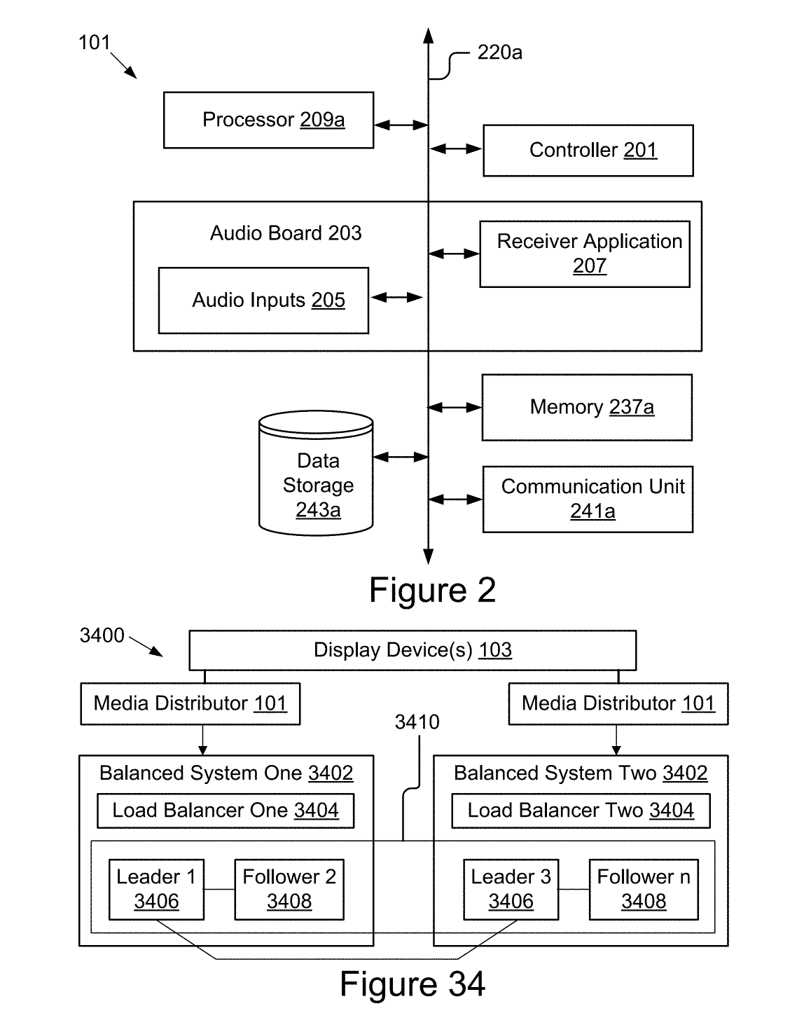

The audio receiver 101 may be a separate device configured to connect to the display device 103 and send the audio and/or video feed of the specific display device 103 to the network 105, e.g., a dongle or separate component box. In further embodiments, the media distributor 101 may be or include software running on a processor of the display device 103 and built into the components of the display device 103. The media distributor 101 will be discussed in more detail with reference to FIG. 2.

FIG. 2 is a block diagram illustrating one embodiment of a media distributor 101 including an audio board 203. The media distributor 101 may also include an output module 205, a processor 209a, a memory 237a, a communication unit 241a, and data storage 243a, according to some examples. The components of the media distributor 101 are communicatively coupled to a bus or software communication mechanism 220a for communication with each other. In some embodiments, the media distributor 101 may be a separate device, while in other embodiments the media distributor 101 may be software and/or hardware built into the display device 103.

The processor 209a may execute software instructions by performing various input/output, logical, and/or mathematical operations. The processor 209a may have various computing architectures to process data signals including, for example, a complex instruction set computer (CISC) architecture, a reduced instruction set computer (RISC) architecture, and/or an architecture implementing a combination of instruction sets. The processor 209a may be physical and/or virtual, and may include a single processing unit or a plurality of processing units and/or cores. Embodiments may include hosted executable images, e.g., in clouds or other virtualization environments. Images may be located at multiple locations, and may be expanded on demand.

In some implementations, the processor 209a may be capable of one or more of the following: generating and providing electronic signals representing information to a display device 103 and/or the client device 115 via the network 105, separating an audio and/or video feed from video content, performing audio and/or video filtering to improve the sound quality of an audio and/or video feed, or altering the characteristics of the audio and/or video feed.

In some implementations, the processor 209a may be coupled to the memory 237 via the bus 220 to access data and instructions therefrom and store data therein. The bus 220 may couple the processor 209a to the other components of the media distributor 101 including, for example, the memory 237, the communication unit 241, and the data storage 243. From a developer perspective, the memory 237 may be local physical memory or remote virtual memory provided on demand. It will be apparent to one skilled in the art that other processors, operating systems, sensors, displays and physical configurations are also possible according to the teachings herein.

The memory 237a may store and provide access to data for other components of the media distributor 101. The memory 237a may be included in a single media distributor 101 or distributed among a plurality of media distributors 101 as discussed elsewhere herein. In some implementations, the memory 237a may store instructions and/or data that may be executed by the processor 209a. The instructions and/or data may include code for performing the techniques described herein. For example, in one embodiment, the memory 237a may store the information for receiving and/or transmitting an audio and/or video feed. The memory 237a is also capable of storing other instructions and data, including, for example, an operating system, hardware drivers, other software applications, databases, etc. The memory 237a may be coupled to the bus 220a for communication with the processor 209a and the other components of the media distributor 101.

The memory 237a may include one or more non-transitory computer-usable (e.g., readable, writeable) devices, a static random access memory (SRAM) device, an embedded memory device, a discrete memory device (e.g., a PROM, FPROM, ROM), a hard disk drive, or an optical disk drive (CD, DVD, Blu-ray®, etc.) medium. A memory 237a may include any tangible apparatus or device that can contain, store, communicate, or transport instructions, data, computer programs, software, code, routines, etc., for processing by or in connection with the processor 209a. In some implementations, the memory 237a may include one or more of volatile memory and non-volatile memory. For example, the memory 237a may include, but is not limited to, one or more of a dynamic random access memory (DRAM) device, a static random access memory (SRAM) device, an embedded memory device, a discrete memory device (e.g., a PROM, FPROM, ROM), a hard disk drive, an optical disk drive (CD, DVD, Blu-ray, etc.). The memory 237a may be a single device or may include multiple types of devices and configurations.

The illustrated communication unit 241a includes hardware for receiving and transmitting data by linking the processor 209a to the network 105 and other processing systems. The communication unit 241a receives data such as requests from the client device 115 and transmits the requests to the controller 201. For example, a request may be sent to receive an audio and/or video feed from a specific display device 103. The communication unit 241a also transmits information, including information related to an audio and/or video feed for display. For example, in response to a request, the unit 241a may transmit information related to a display device 103 to the client device 115. The communication unit 241a is coupled to the bus 220a.

In one embodiment, the communication unit 241a may include a port for direct physical connection to the display device 103, network 105, or client device 115 or to another communication channel. For example, the communication unit 241a may include an RJ45 port or similar port for wired communication with the other devices.

In another embodiment, the communication unit 241a may include a wireless transceiver (not shown) for exchanging data with the client device 115 or any other communication channel using one or more wireless communication methods, such as IEEE 802.11, IEEE 802.16, Bluetooth® or another suitable wireless communication method.

In yet another embodiment, the communication unit 241a may include a cellular communications transceiver for sending and receiving data over a cellular communications network such as via short messaging service (SMS), multimedia messaging service (MMS), hypertext transfer protocol (HTTP), direct data connection, WAP (wireless access point), e-mail and/or another suitable type of electronic communication. In still another embodiment, the communication unit 241a may include a wired port and a wireless transceiver. The communication unit 241a also provides other conventional connections to the network 105 for distribution of files and/or media objects using standard network protocols such as TCP/IP, RTP (real time transport protocol), GPRS (general packet radio service), GSM (global system for mobile communications) protocols, 4G, 5G, LTE (long term evolution), HTTP, HTTPS and SMTP (simple mail transfer protocol) as will be understood by those skilled in the art. Communication unit 241a may communicate with other devices without specific port assignments and/or with various port assignments.

The data storage 243a is a non-transitory memory that stores data for providing the functionality described herein. The data storage 243a may be a dynamic random access memory (DRAM) device, a static random access memory (SRAM) device, flash memory or one or more other memory devices. In some embodiments, the data storage 243a also may include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. In further embodiments, the data storage 243a may be any data storing and/or containing device configured to temporarily and/or permanently store the data.

In the illustrated embodiment, the data storage 243a is communicatively coupled to the bus 220a. The data storage 243a stores data related to receiving and transmitting an audio and/or video feed and other functionality as described herein. The data stored in the data storage 243a is described below in more detail.

In some embodiments, the audio board 203 may include audio inputs 205 and a receiver application 207. The components of the audio board 203 are communicatively coupled via the bus 220. The components of the audio board 203 may include software and/or logic to provide the functionality they perform as taught herein. In some embodiments, the components can be implemented using programmable or specialized hardware including a field-programmable gate array (FPGA) or an application-specific integrated circuit (ASIC). In some embodiments, the components can be implemented using a combination of hardware and software executable by processor 209. In some embodiments, the components are instructions executable by the processor 209. In some implementations, the components are stored in the memory 237 and are accessible and executable by the processor 209.

The receiver application 207 may include software and/or logic to control the operation of the audio board 203 and communicate information related to the display devices 103 to the audio application 301. For example, the receiver application 207 may receive display device 103 information, including a display device name, audio and/or video feed information, etc., and may organize and present the information such that the audio application 301 may receive the information via the network 105. In further embodiments, the receiver application 207 may be coupled to the communication unit 241a to receive the information and transmit the information via the network 105.

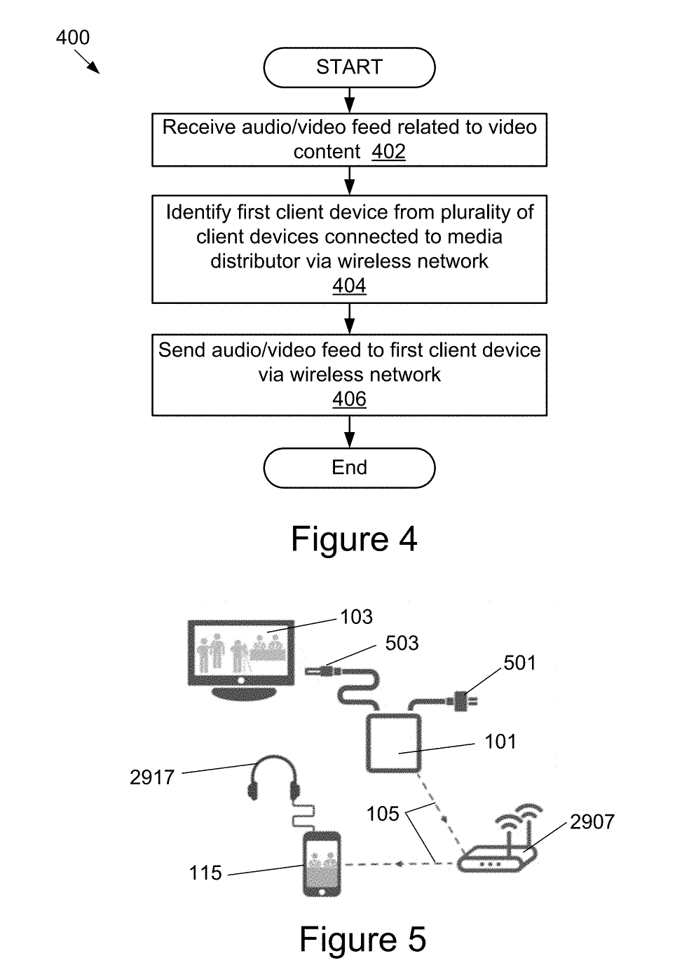

The controller 201 may include software and/or logic to control the operation of the other components of the media distributor 101. In some embodiments, the controller 201 controls the other components of the media distributor 101 to perform the methods described below with reference to FIG. 4 and/or other Figures. In some implementations, the processor 209, the memory 237 and other components of the media distributor 101 can cooperate and communicate without the controller 201.

In some embodiments, the controller 201 sends and receives data, via the communication unit 241a, to and from one or more of a client device 115 and a display device 103. For example, the controller 201 receives, via the communication unit 241a, an audio and/or video feed from the display device 103 and sends the audio and/or video feed to the client device 115 via the network 105. In another example, the controller 201 receives data for controlling the audio and/or video feed from the client device 115 and may manipulate the audio and/or video feed or connection to the audio and/or video feed.

In some embodiments, the controller 201 receives data from other components of the media distributor 101 and stores the data in the data storage 243. For example, the controller 201 may receive an audio and/or video stream and transmit the audio and/or video stream to the client device 115.

The audio board 203 may be software or hardware configured to receive an audio and/or video feed via audio inputs 205 and transmit the audio and/or video feed as described elsewhere herein. In some embodiments, the audio inputs 205 may be hardware inputs configured to receive an audio feed associated with video content presented on the display device 103. In some embodiments, the audio inputs 205 may also be configured to receive video data. In further embodiments, the audio and/or video feed may be a separate audio and/or video feed not associated with video content. In some embodiments, the audio and/or video feed may be received at the audio inputs 205 via a wired and/or a wireless signal.

In some embodiments, the audio inputs 205 may include RCA cables, a 3.5 mm jack, an HDMI (high-definition multimedia interface) cable, a USB (universal serial bus) connection, an optical cable connection, a composite connection, an S-Video connection, a coaxial cable connection, etc.

In further embodiments, the audio board 203 may be software and the audio inputs 205 may be software connections configured to receive and/or send an audio and/or video feed.

In other embodiments, the media distributor 101 may receive and/or send the audio and/or video feed via the communication unit 241 and the audio board 203 and audio inputs 205 may be unnecessary. In some embodiments, the audio board 203 or other audio processing unit may be separate from the rest of the media distributor 101. In further embodiments, the audio board 203 or other audio processing unit may connect to the components including a processor, a memory, a controller, etc. of the display device 103, rather than using the internal components of the media distributor 101.

FIG. 3 is a block diagram illustrating one embodiment of a client device 115 including a media application 117. The client device 115 may also include a processor 209b, a memory 237b, a communication unit 241b, and data storage 243b according to some examples. The components of the client device 115 are communicatively coupled to a bus or software communication mechanism 220b for communication with each other. The processor 209b, controller 201b, memory 237b, communication unit 241b, and data storage 243b perform functions similar to the corresponding components described above with reference to FIG. 2.

In some implementations, the processor 209b may be capable of generating and providing electronic signals representing information to the client device 115. The information may include an audio and/or video feed received from the communication unit 241b via the network 105. In some implementations, the processor 209b may be coupled to the memory 237b via the bus 220b to access data and instructions therefrom and store data therein related to the client device 115. The bus 220b may couple the processor 209b to the other components of the client device 115 including, for example, the memory 237b, the communication unit 241b, and the data storage 243b. It will be apparent to one skilled in the art that other processors, operating systems, sensors, displays and physical configurations are possible to achieve the functionality taught herein.

The media application 117 may be software or hardware and include a display selection module 307, an auto switching module 309, an audio control module 311, and a user interface module 313. The media application 117 may include software and/or logic to control the receiving of the audio and/or video feed and the displaying of information related to the display devices 103. For example, the media application 117 may receive television show schedules and provide them for display on the client device 115. In some embodiments, a list of television shows can be captured and displayed to a user such that a user can schedule reminders (which may be synced with various calendar applications on the client device 115) and record those television shows on the client device 115, if the display device 103 and the media application 117 are operating together. In further embodiments, the media application 117 may receive various information related to the display device 103.

For example, the media application 117 may recognize a mood of the audio and/or video feed (e.g., genre) and send a request to a third party application controlling a lighting or display of the room to set the lights and/or theme of a location to that specific genre. Moods may be recognized using, e.g., predefined triggers or tags, neural network or other machine intelligence, or a predefined list correlating audio/video metadata with enumerated moods.

In further embodiments, the media application 117 may store the selections of various display devices 103 and/or programming selected on the display device 103. The media application 117 may be configured to analyze a plurality of the selections and determine trends or commonalities between the selections. In further embodiments, the media application 117 may incorporate artificial intelligence and/or machine learning to determine the trends and provide suggestions for future programming based on the determined trends.

The display selection module 307 may include software and/or logic to receive a selection of a display and communicate to the receiver application 207 of the media distributor 101 that a specific display device 103 has been selected and the audio and/or video feed related to the selection should be provided to the client device 115. In some embodiments, the display selection module 307 may receive a selection and identify a media distributor 101 associated with a display device 103 of interest and initiate a connection with the media distributor 101 associated with the display device 103 of interest via the network 105. Other functionality of the display selection module 307 is described elsewhere herein.

In some embodiments, the display selection module 307 may be configured to receive a video feed from a video capture device coupled to the communication unit 241b. A user may point the video capture device at a display device 103 and the display selection module 307 may identify which display device the user is pointing the video capture device at. In some embodiments, the display selection module 307 may perform image processing techniques to identify a unique identifier 2925 (e.g., QR code, color scheme, labeling, etc.) to identify the display device being captured by the video feed. In further examples, the media selection module 307 may compare a media feed (e.g., audio, video, etc.) captured in the video feed to a database of media content to identify content included in the media feed and determine an identity of a display device connected to the network that is receiving the identified media feed. The display selection module 307 may then automatically connect to that specific media distributor 101. In some embodiments, this process may be initiated by a user selecting a user-selectable icon on a client device 115.

Auto switching module 309 may include software and/or logic to switch an audio and/or video feed from one media distributor 101a to a different media distributor 101b. In some embodiments, the switching may occur based on a location and in response to the auto switching module 309 detecting a change in location, switching to a different media distributor 101.

A change in location may be determined by location data from a location sensor on a client device 115. The location sensors may include geolocation data such as positional coordinates from sensors including GPS, wireless signal location, Bluetooth location, wireless connection to routers in specific locations, etc. The auto switching module 309 may receive administrative information related to locations of various media distributors 101 and identify a closest media distributor 101 to initiate an automatic connection.

In some embodiments, criteria other than which is the closest media distributor 101 may be used to determine a different media distributor 101 to connect with. In some embodiments, the auto switching may occur based on events other than a location change, such as a scheduled (by the user as a preference) TV show starting on a specific display device 103 and the media application 117 switching over to connect to that specific display device 103. Other criteria may be, e.g., favoring specific video content displayed based on input and/or learned user preferences, previously connected media distributors 101, user content preferences, mood maintenance, genre continuity, etc. Switching to a different media distributor, namely, a different content source, may be done in some embodiments to (a) continue providing the same content from another source, or to (b) provide the next most preferred content from another source if the same content is unavailable and the next most preferred content is unavailable on the current source.

Audio control module 311 may include software and/or logic to adjust presentation characteristics of an audio and/or video feed. Examples of presentation characteristics may include volume, bass, treble, balance, etc. of an audio feed and/or brightness, contrast, aspect ratio, etc. of a video feed. In some embodiments, the audio control module 311 may adjust an output volume of the client device 115. In further embodiments, the audio control module 311 may adjust a volume related to the audio and/or video feed from the media distributor 101. In further embodiments, the audio control module 311 may filter noise using specific hardware components and/or using digital filtering methods. Noise reduction may be performed using hardware and/or software logic, and may be configured for electrical and/or environmental noise reduction, single- or double-ended system noise reduction, electrical hiss reduction, ambient environmental noise reduction, or a combination thereof.

In further embodiments, the audio control module 311 may also determine whether the audio and/or video feed and the video content displayed on the display device 103 are in sync. If the audio and/or video feed and the video content are out of sync, then the audio control module 311 may identify the timing difference between them and skip forward on the audio and/or video feed to sync with the video content. In further embodiments, a sync button (or a “fix” button) may be displayed on the client device 115 by the user interface module and in response to the sync button being selected, the audio control module 311 may sync the timing of the audio and/or video feed to the video content as described herein.

User interface module 313 may include software and/or logic to display various user interfaces on a display of the client device 115 when a user is using the audio application 301. For example, the user interface module 313 may generate a user interface for various screens of the audio application 301, as described elsewhere herein. In further embodiments, the user interface module 313 may determine placement of various advertisements and/or announcements (e.g., any other content that may be provided to a user via the user interface module 313) in the generated user interfaces based on various parameters, including size, type of content, time period being displayed, etc.

In some embodiments, the client device 115 may include a client device display (not shown in this Figure) that may display electronic images and data output for presentation to a user. The client device display may include any conventional display device, monitor or screen, including, for example, an organic light-emitting diode (OLED) display, a liquid crystal display (LCD), etc. In some implementations, the client device display may be a touch-screen display capable of receiving input from one or more fingers of a user. For example, the client device display may be a capacitive touch-screen display capable of detecting and interpreting one or multiple points of contact with the display surface. In some implementations, the client device 115 may include a graphics adapter (not shown) for rendering and outputting the images and data for presentation on client device display. The graphics adapter (not shown) may be a separate processing device including a separate processor and memory (not shown) or may be integrated with the processor 209b and memory 237b. In further embodiments, the client device 115 may be a wearable and/or virtual device, (e.g., software simulation system, system that directly communicates to a user without a display, etc.)

In some embodiments, the client device 115 may also include an input device (not shown) that may include any device for inputting information into the client device 115. In some implementations, the input device may include one or more peripheral devices. For example, the input device may include a keyboard (e.g., a QWERTY keyboard), a pointing device (e.g., a mouse or touchpad), a microphone, a camera, etc. In some implementations, the input device may include a touch-screen display capable of receiving input from one or more fingers of the user. For instance, the functionality of the input device and the client device display may be integrated, and a user of the client device 115 may interact with the client device 115 by contacting a surface of the client device display using one or more fingers. For example, the user could interact with an emulated (i.e., virtual or soft) keyboard displayed on the touch-screen display by using fingers to contact the display in the keyboard regions.

FIG. 4 is a flowchart 400 of an example method for providing a wireless audio and/or video feed to a client device 115. At 402, the media distributor 101 receives an audio and/or video feed from a display device 103. In some embodiments, the audio and/or video feed may be related to video content presented on the display device 103. In further embodiments, the audio and/or video feed may be related to program information and/or close captioning of the video content. The media distributor 101a may be connected to a single display device 103a. In further embodiments, the media distributor 101a may be connected to multiple display devices 103 and a user may use a client device 115 to select which audio and/or video feed to receive from the multiple display devices 103. In some embodiments, the media distributor 101 may be situated proximate to the display device 103. In further embodiments, the media distributor 101 may be situated in alternative locations (e.g., for easier visibility, to increase reception, to make the media distributor 101 more accessible, etc.) The media distributor 101 may be coupled to the display device 103 in many different ways as described elsewhere herein (e.g., USB, 3.5 mm Audio Jack, HDMI, A/V connectors, or other connectors 503)

At block 404, the receiver application 207 identifies a first client device 115a from a plurality of client devices 115 connected to the media distributor 101 via the network 105. In some embodiments, the first client device 115a may be the only client device 115 connected to the media distributor 101. In further embodiments, the plurality of client devices 115 may simultaneously be connected to the same media distributor 101 and receive the same and/or different audio and/or video feeds.

The receiver application 207 may identify the first client device 115a by identifying a request from the first client device 115a to receive an audio and/or video feed. The request may be received by the communication unit 241 via the network 105 in the form of a wired and/or wireless signal. A user may institute the request on a client device 115 through an audio application 301. In further embodiments, the request may be sent automatically in response to a trigger event, such as moving to a new location, signing into a device that had previously connected to the receiver application or media distributor or both, using a default setting, turning on the display device 103 that the client device 115 is connected to, starting the media application 117, etc.

At block 406, the receiver application 207 sends the audio and/or video feed to the first client device 115a via the network 105. In some embodiments, the audio and/or video feed may include any media content including an audio feed, a video feed, a GIF (graphics interchange format) file, a document, a song, etc. The audio and/or video feed may be sent via a wireless network 105 such as a Wi-Fi signal. In further embodiments, the audio and/or video feed may be sent via a Bluetooth signal. Sending the audio and/or video feed via a Wi-Fi network increases the range (hundreds of feet depending on if the signal is broadcast inside or outside, compared to 30 feet for Bluetooth.) Sending the audio and/or video feed via the Wi-Fi network increases the transfer rate (e.g., 600 Mbps or greater, compared to 2.1 Mbps) and greater bandwidth (e.g., 11 Mpbs or greater, compared to 800 Kbps) which allows for higher sound quality, a faster rate of transmission, and/or larger audio and/or video feed files being transferred. Sending the audio and/or video feed via the Wi-Fi network increases the connectivity, allowing multiple client devices 115 to connect to a single network, compared to a traditional Bluetooth network that generally only connects a single device at a time. In further instances, the media distributor 101 may connect to existing wireless networks that the client device 115 may have already connected to or may easily be configured to connect to, making a connection over the wireless network simple for a user to receive an audio and/or video feed.

FIG. 5 is an embodiment of a graphical representation of a wireless distributed audio and/or video system. In this example, a single client device 115, which is connected to headphones 2917, also connects to the single audio receiver 101 over the network 105 using a router 2907. The single media distributor 101 may also be connected to the network 105 using the router. In further embodiments, as shown in FIG. 7, the media distributor 101 may communicate directly with the client device 115 without an intermediary (e.g., a router, etc.).

In some embodiments, the media distributor 101 may include a plug 501 for a power supply. In further embodiments, the media distributor 101 may include an internal power supply, such as a battery and/or rechargeable battery.

In further embodiments, the media distributor 101 may connect to the display device's 103 power supply. In this example, the display device 103 is presenting video content and is coupled through a connector 503 directly to the media distributor 101 using the “audio out” connection of the display device 103. In this embodiment, a single user can receive the audio and/or video feed using their client device 115 to connect over the network 105.

FIG. 5 describes an example suitable for home use, which may simultaneously connect multiple client devices (e.g., in a non-limiting example up to twenty mobile devices, while other options are also contemplated) to a single media distributor 101. In this example, users will be able to connect various devices to televisions or other display devices 103 in a home/business setting and will be able to listen to audio and/or video feeds at ease using their home wireless network 105.

In some embodiments, the home use example may allow for assistive listening and increasing the volume for specific users that have hearing impairments. For example, a user that suffers from various stages of hearing loss can watch the same video content presented to others (or just watch alone) in a room and, using the media distributor 101, can increase the volume on a personal set of headphones to hear the audio feed without increasing the audio from the display device 103. In another example, a user may receive an audio feed via a pair of headphones plugged into his/her client device and listen to a TV program being displayed on the display device 103 without disturbing his/her spouse who is sleeping in the room. Some embodiments provide or serve as a Personal Sound Amplification Product (PSAP) or an Assistive Listening Device (ALD) in compliance with standards such as the Consumer Technology Association audio output standards for such products and assistive devices. In some cases, software on the user's smartphone or other device, which is intermediary between the user and the media distributor, enforces compliance with the audio output standard(s). In some cases, the media distributor enforces audio output standards compliance. Some embodiments provide separate volume controls, frequency filters, or other controls for each ear. Some provide an equalizer to adjust the degree of amplification across frequencies. Some permit saving per-ear profiles in files. Some have an always-on recording mode with a sliding window, so that the most recent 30 seconds (for instance) of audio are available for replay. Some permit automatic settings for the volume, frequencies, tone control, and/or other parameters, per ear, in response to a hearing test conducted by a user with the aid of a wizard or tutorial.

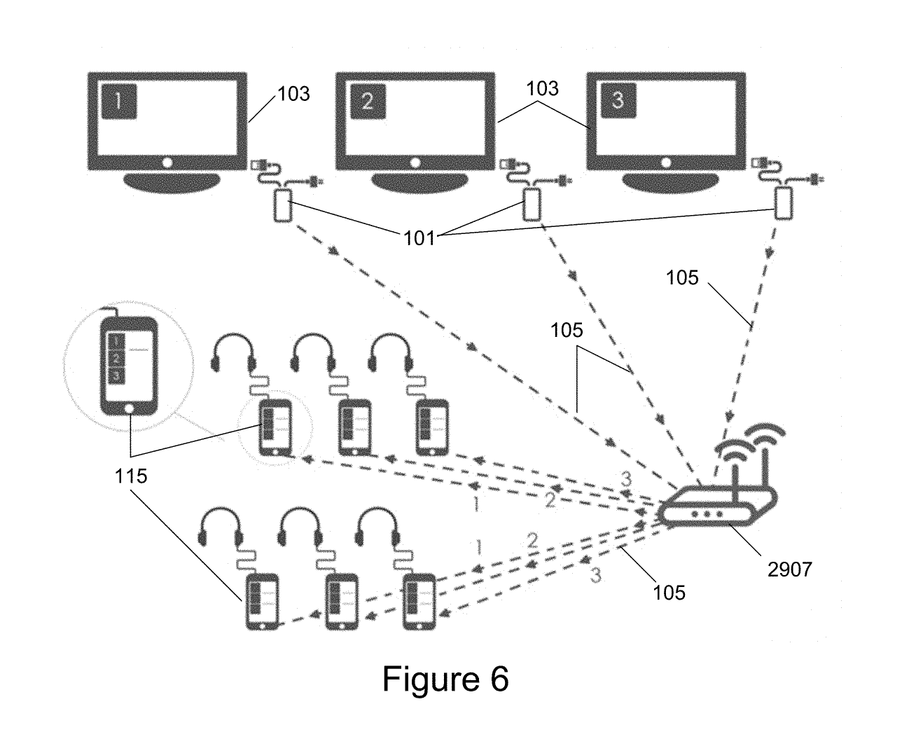

FIG. 6 shows another embodiment of a graphical representation of a wireless distributed audio and/or video system. In this embodiment, multiple client devices 115 may simultaneously be communicatively coupled to a single network 105 via a router. In further embodiments multiple connection points, (e.g., routers) may also be used to connect multiple client devices 115. Multiple media distributors 101 may also each be individually connected to display devices 103. Each of the media distributors 101 may also be coupled to the network 105 via the router. A user of a client device 115 may select any of the display devices 103 (designated with a “1”, “2”, or “3” on the respective screen in the example) and receive the audio and/or video feed for the video content displayed on the selected display device 103.

FIG. 6 describes an example suitable for small business use, which may simultaneously connect multiple client devices (e.g., in a non-limiting example up to one hundred mobile devices to each of the audio and/or video sources, while other options are also contemplated) to multiple media distributors 101. In this example, users will be able to connect to the network 105 and select an audio and/or video feed from multiple display devices 103 to receive through their client device 115. Small or medium-sized businesses such as sports bars, music venues, gyms, airport locations, hotels, amusement parks, museums, stores, assisted living and/or group living settings, may use such configurations. Load balancing may be performed, using a mesh network or otherwise as described elsewhere herein.

FIG. 7 shows another embodiment of a graphical representation of a wireless distributed audio and/or video system. In this embodiment, multiple client devices 115 are present. They are not shown expressly, but are indicated by the people 2804 shown. In a non-limiting example, over a hundred mobile devices may be connected to each of the audio and/or video sources. In some cases, devices 115 may be simultaneously connected to a single media distributor 101 via a network. In some embodiments, the connection may be directly to the media distributor, which may include a router or other means to provide a WLAN signal to the client devices 115. In further embodiments, the connection may be via a network 105 to the media distributor 115. The multiple client devices 115 may simultaneously receive an individual audio and/or video feed.

In some embodiments, the individual audio and/or video feed may be associated with video content 701 displayed on a single display device 103. For example, users at a sporting event may connect their mobile phone (one example of a client device 115) using an audio application 301 to a network 105 at the sporting event and receive an audio and/or video feed related to the video content displayed on a giant screen (one example of a display device 103) at the sporting event. Note that the “screen” in question may be a virtual screen, such as one created by a holographic or other projection mechanism. Screens and projection mechanisms are collectively referred to herein as “displays” or “display mechanisms”. Projection mechanisms may include a screen upon which images are projected, but may also merely include the lenses, light sources, and image data sources which contribute to image generation, without necessarily including the screen or other material on which the images are projected.

In this sporting event example, users can easily connect the device they already have with them, and use personal headphones without having to purchase or bring to the event any other hardware to receive the audio and/or video feed. In some situations, audio content is being delivered from a speaker built into a display device, or from speakers near the display device, but is not easily heard and understood at a distance (e.g., at least five meters, and in sports venues, this could be even greater, such as tens of meters) where the user is located. In such situations, a copy of the audio, which is streamed from the user's personal headphones, ear buds, or smartphone speaker, may be much easier for the user to hear and understand.

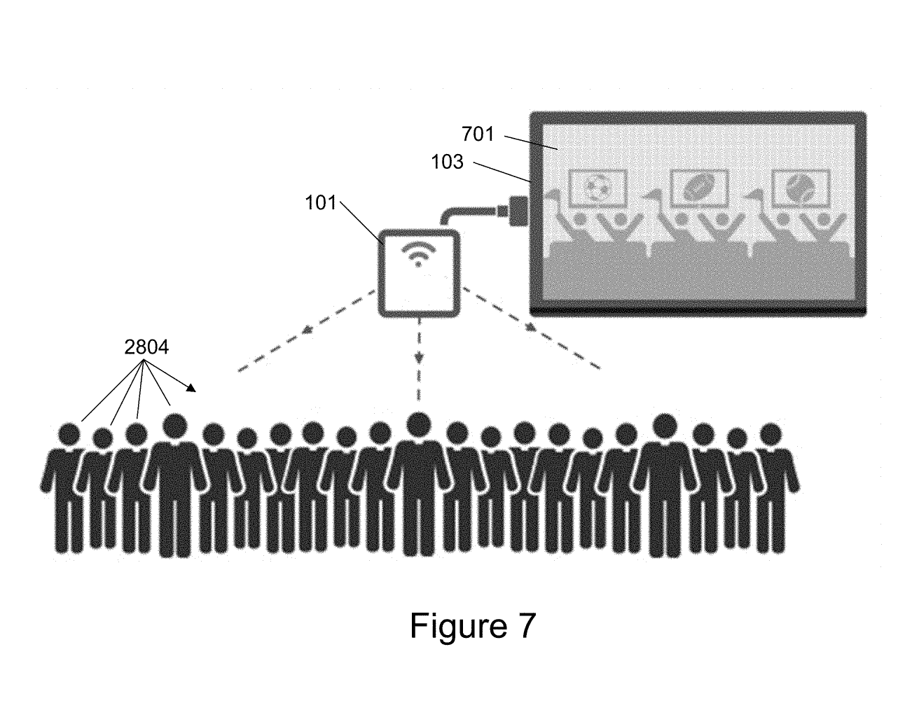

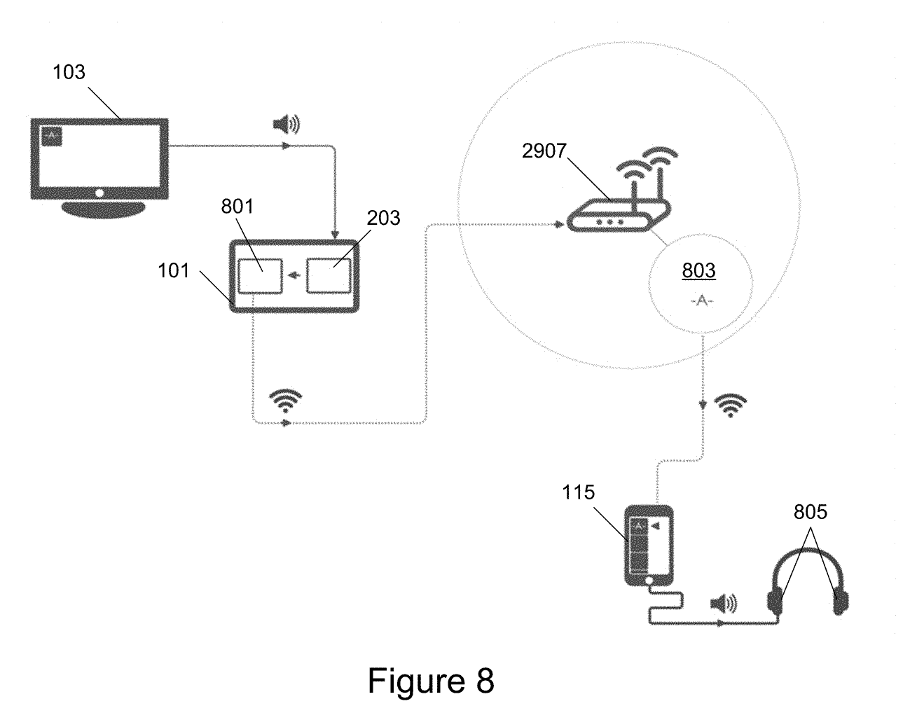

FIG. 8 shows another embodiment by a graphical representation of a wireless distributed audio and/or video device system. In this embodiment, the display device 103 displays video content and provides an audio and/or video feed to the media distributor 101. In this embodiment, the media distributor 101 is a piece of hardware that may include an audio board 203 to receive the audio and/or video feed and a main board 801 to process and transmit the audio and/or video feed over the wireless network via the router 2907. A multicast group 803 A may be a logical audio channel. In this example, a single client device 115 may be connected via the multicast group A. The multicast group A may allow future connections with other client devices 115 through the multicast group A connected to the media distributor 101. The client device 115 receives the audio and/or video feed from the multicast group and provides the audio and/or video feed to one or more speakers 805, e.g., headphones, Bluetooth speaker, wired speakers, etc. Multicast groups or classes may be load-balanced relative to one another. In addition to, or in place of multicast addresses, broadcast, unicast, or (in IPv6) anycast addresses may be used to carry audio content.

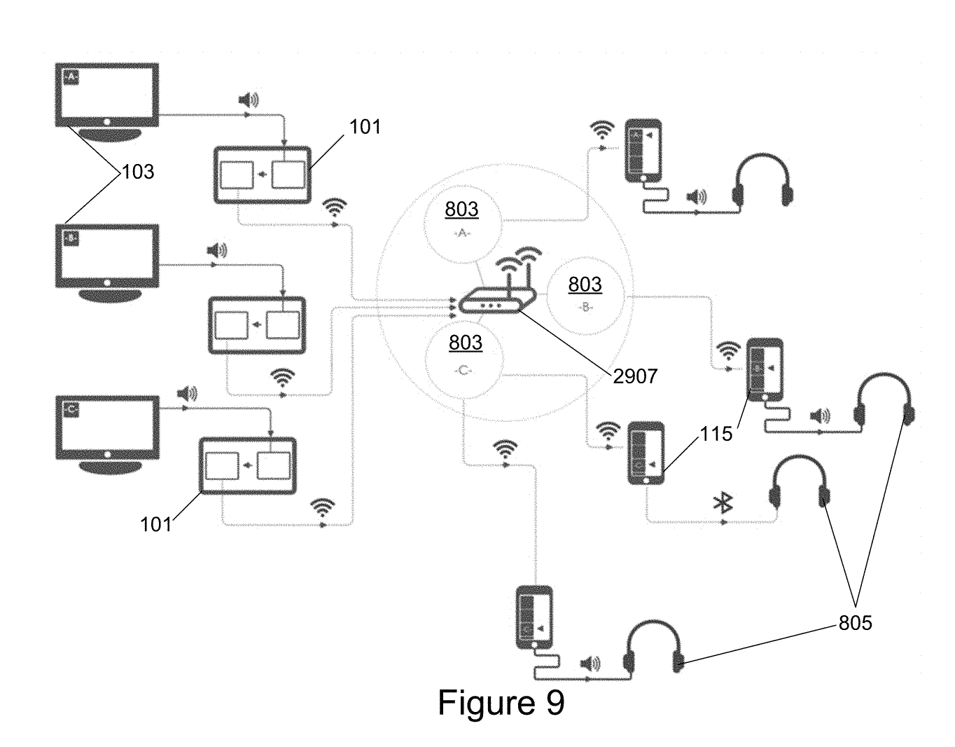

FIG. 9 shows another embodiment of a graphical representation of a wireless distributed audio and/or video device system. In this example, similar to FIG. 8, client devices 115 are connected through a router 2907 to different media distributors 101 connected to display devices 103. In this example, multicast groups 803 labeled here A, B, and C are present. These multicast groups are logical audio channels. In a case where several media distributors 101 are connected over the same network via a router, the multicast groups provide a mechanism for different client devices 115 to distinguish between the different media distributors 101. In some embodiments, a single multicast group represents a single media distributor and multiple of the client devices connect to the audio and/or video stream from the media distributor.

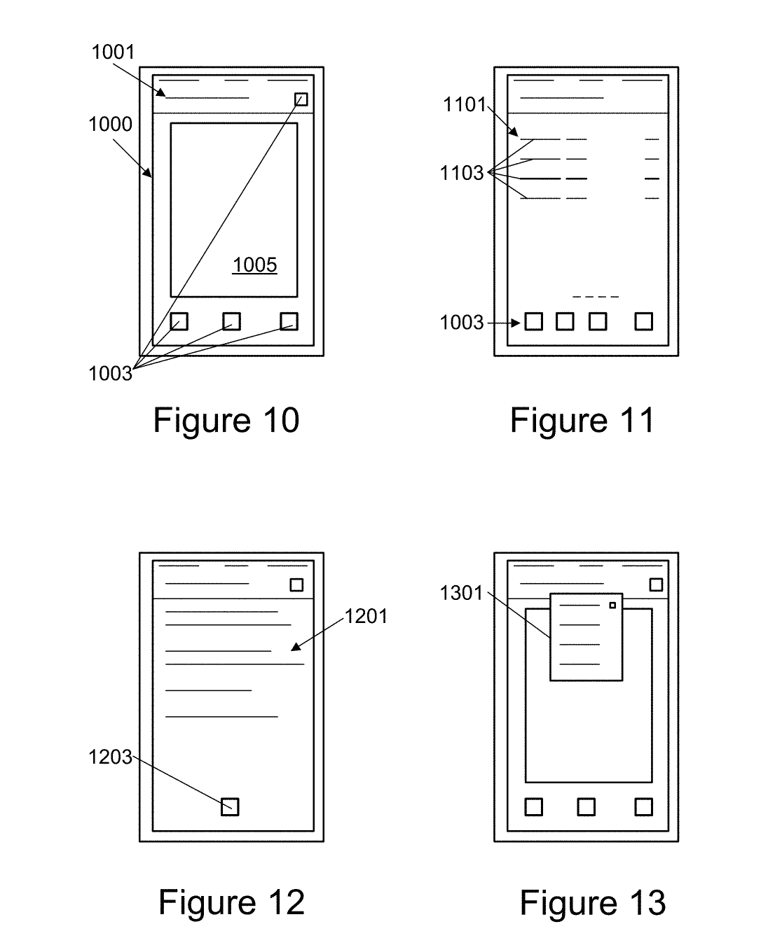

FIGS. 10-13 are example embodiments of a graphical user interface (GUI). FIG. 10 shows an example GUI 1000 displayed on the client device 115 by the user interface module 313, in which text is represented by line segments to conform with patent office practice, avoid undue limitation, and reduce language translation burdens. In this embodiment, the GUI displays the display device 103 name 1001, e.g., “TV 1” as well as some command tools 1003 such as an audio indicator, record button, and file setting. In further embodiments, other command tools and/or command tool configurations can be displayed on the display by the user interface module 313.

In some embodiments, an advertisement 1005 may be displayed on the screen. The advertisement space can be sold to advertising companies to display advertisements when users access the audio application 301. In some embodiments, the advertisement may display when the audio application 301 is initiated and may display images and/or sounds of an advertisement. In further embodiments, a tone and/or haptic feedback event may be provided to indicate to a user when the advertisement has been completed. A user may select the audio indicator on the client device 115 to indicate a desire to connect to an available media distributor 101. In some embodiments, advertisement display is automatically reduced or prevented when the user client device location is determined by geolocation to be at the user's residence. In some embodiments, advertisement display of advertising content identified by or tailored to a given business entity is automatically increased or enabled when the client device location is determined by geolocation to be at one of the business entity's locations.

In some embodiments, after selection of the record button a recording status with time section is displayed. In some embodiments, a recording of an audio and/or video feed may be saved in storage or uploaded to a cloud. The recording may be in an mp3 or other familiar format. The recording may be accessible for future use via the client device 115. In further embodiments, the recording may be uploaded to a cloud storage and be accessible by other users. FIG. 11 shows a list 1101 of various recordings 1103 that have been previously recorded and are selectable by a user. In some embodiments, the recordings may display a date and length of the recording. A command 2452 tool 1003 display showing tool icons for stop, start, play, pause, forward, and/or backward control actions 1605 may be displayed. The display may also show the title and time of what is playing. In some embodiments, particularly those used to assist hearing impaired users, a buffer holds a current recording of the most recent audio, e.g., the most recent thirty seconds (or more if a recent recording is being reviewed), which can be replayed to catch information that was missed. It may also be possible to speed through this or other recordings as faster playback rates, e.g., 1.5 or 2 times normal rate.

FIG. 12 displays instructions 1201 of one example of how to connect to a media distributor 101. In this example, a user may connect a client device 115 to the audio receiver by first, connecting to the network 105 that the media distributor 101 is connected to. Second, selecting a display device 103 name. In some embodiments, if the display device 103 does not show up, a refresh button may be displayed that will refresh the list of available display devices 103. Third, after the display device 103 name is available, the display device (e.g., TV 1) can be selected to connect to the audio application 301. An audio indicator icon 1203 is displayed to indicate the availability of audio if the instructions are followed.

FIG. 13 shows one example of how a listing 1301 of display devices 103 (e.g., TV Name 1, TV Name 2, TV Name 3, TV Name 4) may be presented to a user for the user to make a content selection in the form of a display device selection. A drop down menu listing 1301 is shown, but other GUI presentations may also be used to provide the user with a listing 1301, e.g., thumbnails, scrollable lists, tiles, and so on.

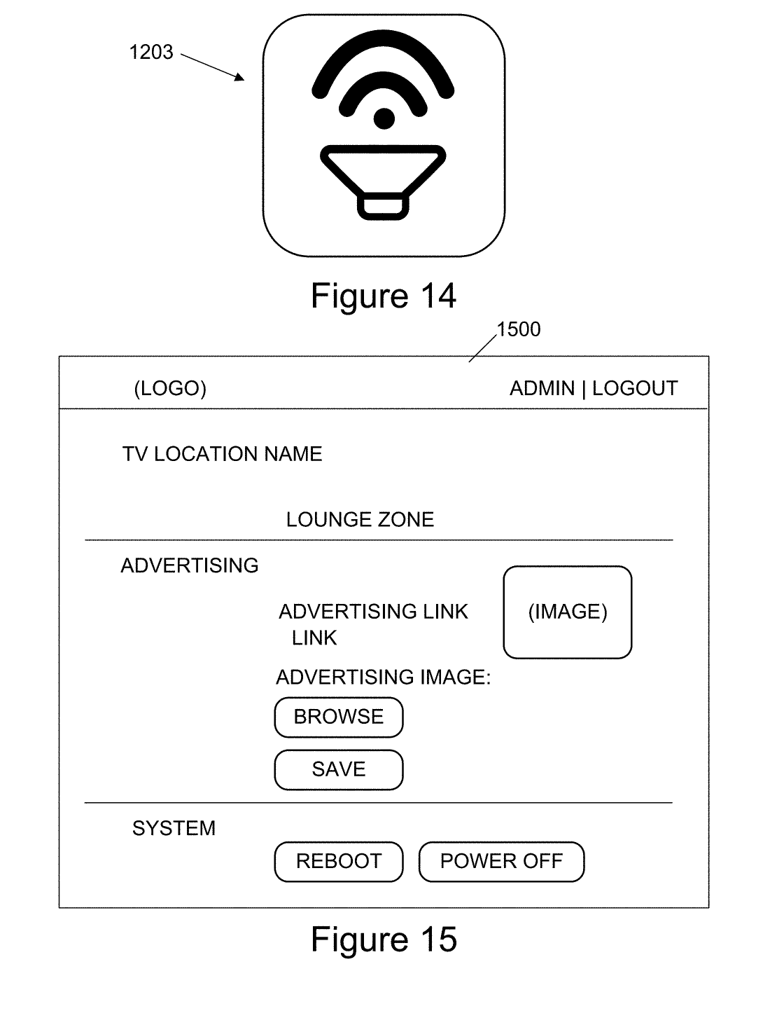

FIG. 14 shows another example of an embodiment of an audio indicatoricon 1203. The audio indicator may appear in the GUI in various sizes, and other images of the audio indicator may also be used, including in particular only a stylized waves portion of the icon. The audio indicator icon may also displayed on the display of the display device 103, to indicate the availability of customized audio as taught herein.

FIG. 15 shows another example of a graphical user interface. In this embodiment 1500, an administrative menu may be displayed on a client device 115 display (e.g., a mobile device or a computer connected to the network 105.) The administrative menu may display details of a specific display device 103. The details may include a display device location that may be editable by a user in the administrative menu. The details may further include advertising information and a user may select a specific advertisement and provide images, links, details, post, manage, edit etc., to configure the advertisement to be displayed on specific audio applications 301 of the client devices 115 as audio applications 301 are configured to receive audio and/or video feeds of specific display devices 103. In further embodiments, the advertisement feeds and administrative menu may be stored on a server and may be customizable by other users remotely on other devices separate from the local network 105. The administrative menu may also provide system functions, such as rebooting or powering off the distributed wireless audio and/or video transmission system.

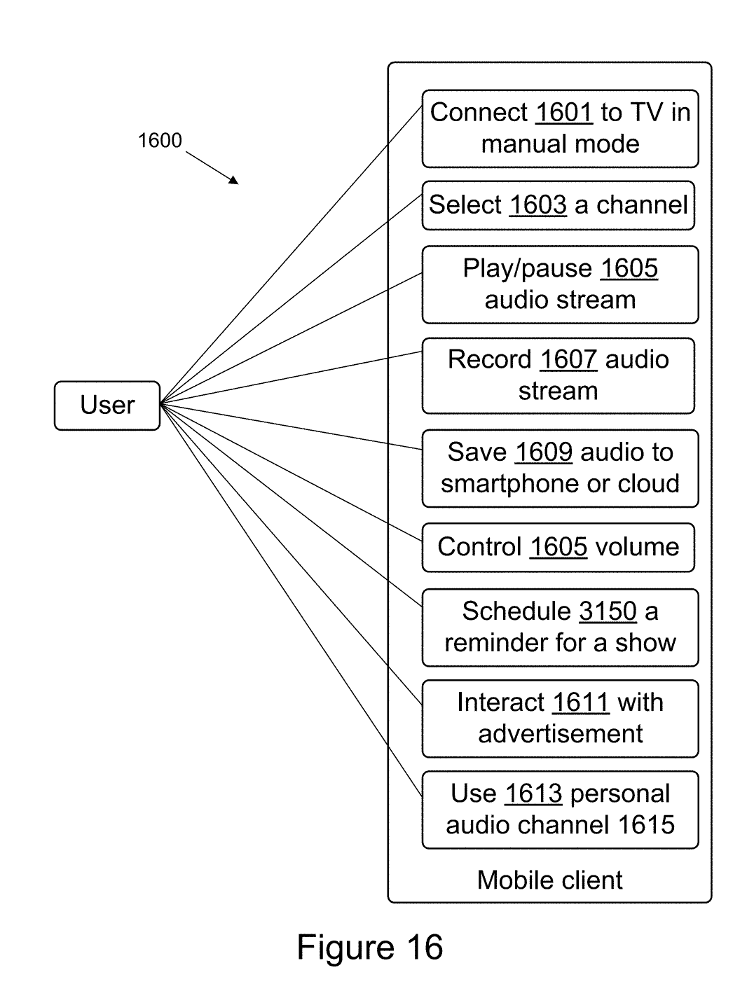

FIG. 16 shows a graphical representation of a chart 1600 of audio application functionalities. The audio application 301 may allow a user of a client device 115 to interact with the audio application 301, connect 1601 a TV in manual mode, select 1603 a channel, play/pause 1605 an audio and/or video stream (audio feed), record 1607 an audio and/or video stream (audio feed), save 1609 audio and/or video to a smartphone (client device 115) or cloud, control 1605 volume, schedule 3150 a reminder for a show, or interact 1611 with an advertisement as described elsewhere herein. In some embodiments, a user can record audio while listening to an audio broadcast. Each record is saved in a special section of the application with the exact date of recording and the name of the device. The user can play any record and can send it via e-mail. In some embodiments, a user can store some or all of the records in cloud storage.

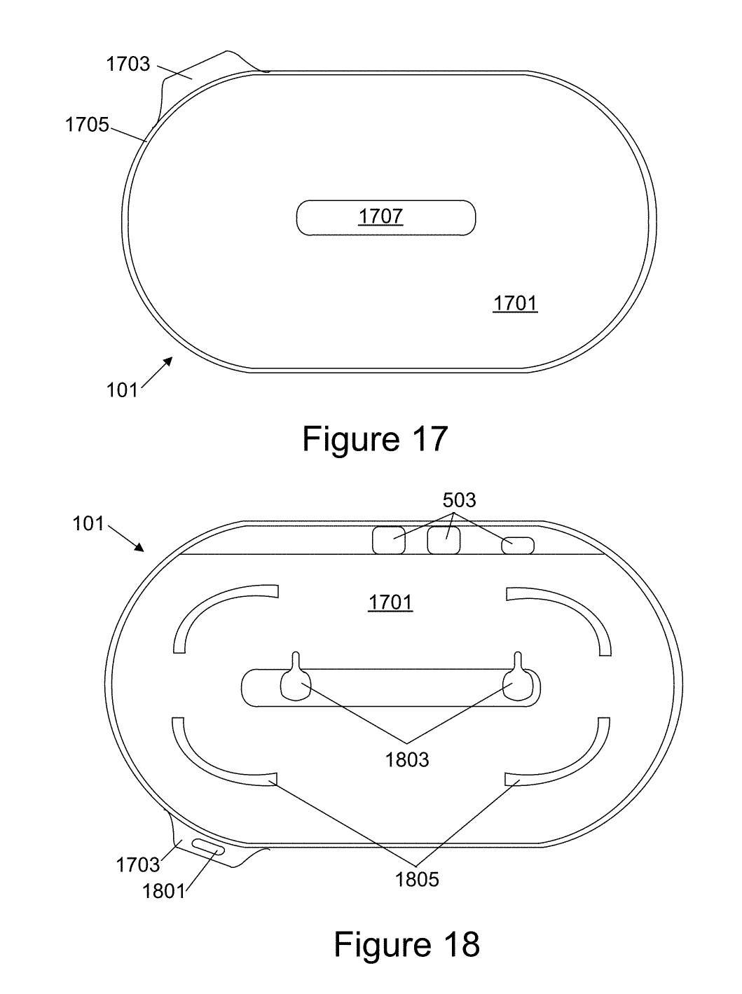

FIGS. 17 through 24 display views of an example embodiment of a media distributor. FIG. 17 displays a top view of an example media distributor 101. The media distributor 101 may be in an oval-shaped housing 1701 that includes one or more tabs 1703 to affix a label or indicator, which will be visible to users near (e.g., within a foot of) the TV or display that is connected to the media distributor. In some embodiments, the housing may be made of plastic with a rubber edge 1705 to allow for easy handling. A region 1707 may bear a trademark of the vendor who provides the distributor 101.

FIG. 18 displays a bottom view of the example media distributor 101, which resembles the example in FIG. 17 but a projection 1801 from the tab 1703 is visible. As illustrated, the housing 1701 may include attachment prongs 1803 to mount the media distributor 101 to a television, wall, or other surface. Audio, video, or power connectors 503 are also visible. Integrally molded ridges 1805 may be present to support airflow spacing and/or provide structural reinforcement.

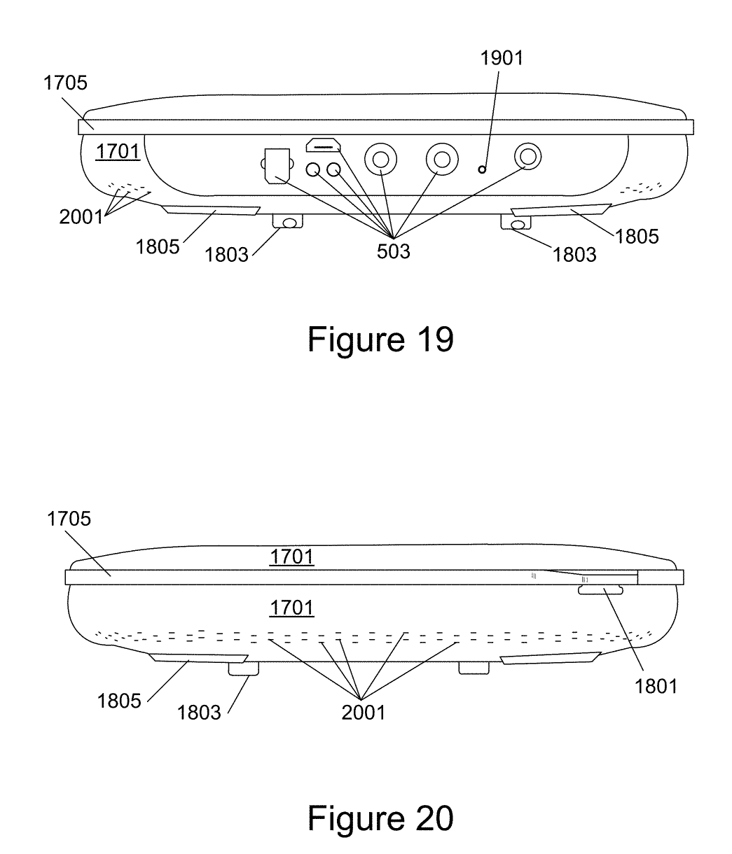

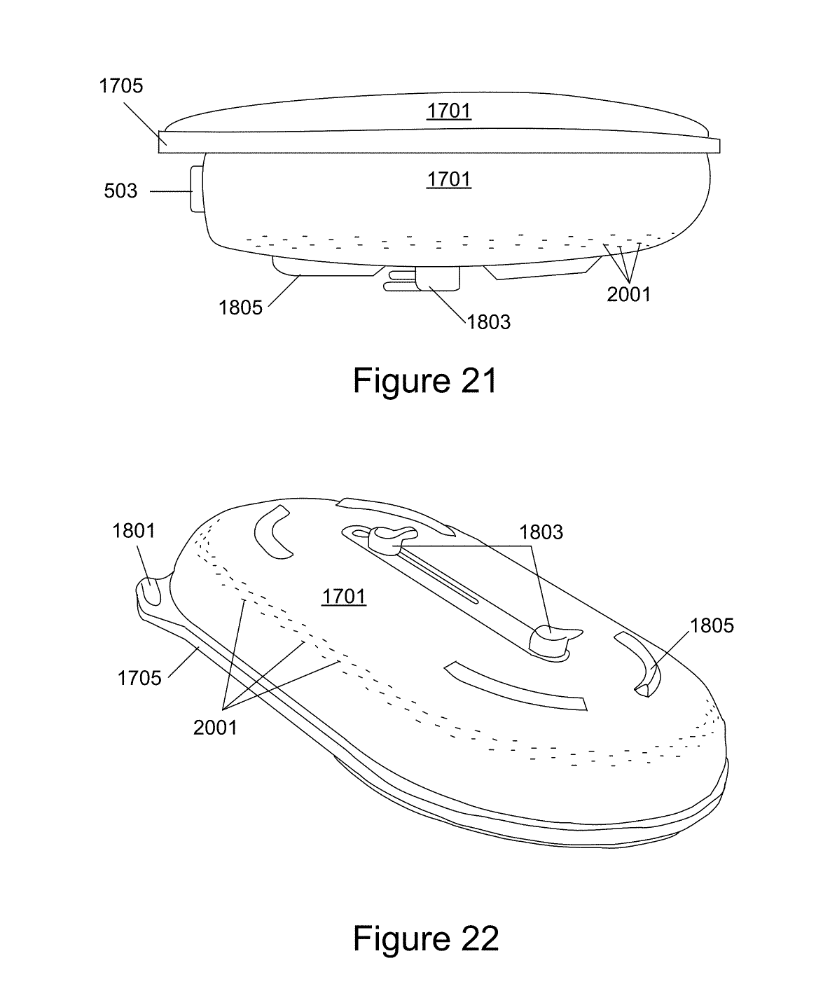

FIG. 19 shows a front view of the example media distributor 101. The media distributor 101 may include various audio inputs 205 described elsewhere herein, and other connectors 503. The housing may be cutout to allow access to the audio inputs 205. In some embodiments, the housing may extend along the top, past the audio inputs 205 to hide the audio inputs from view when the audio input device 101 is mounted; this is also shown in FIGS. 21 and 24. A hole for access to a manual reset 1901 may be provided.

FIG. 20 is a back (rear) view of the example media distributor 101. The housing may include vents 2001 to dissipate heat through the housing.

FIG. 21 is a side view of the example media distributor 101.

FIG. 22 is a bottom perspective view of the example media distributor 101.

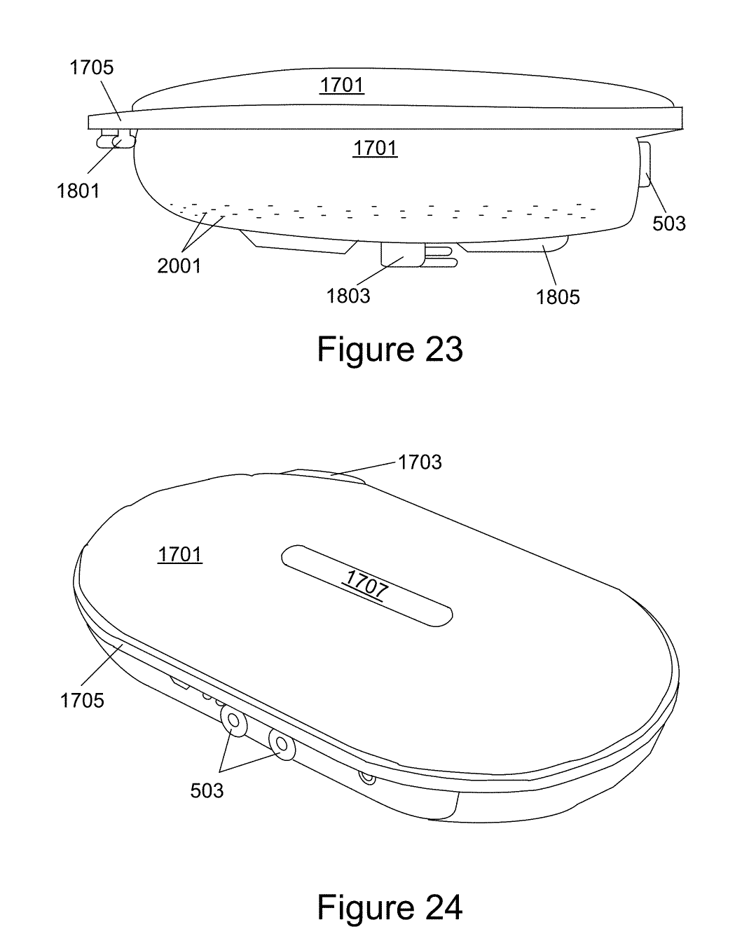

FIG. 23 is another side view of the example media distributor 101.

FIG. 24 is a top perspective view of the example media distributor 101.

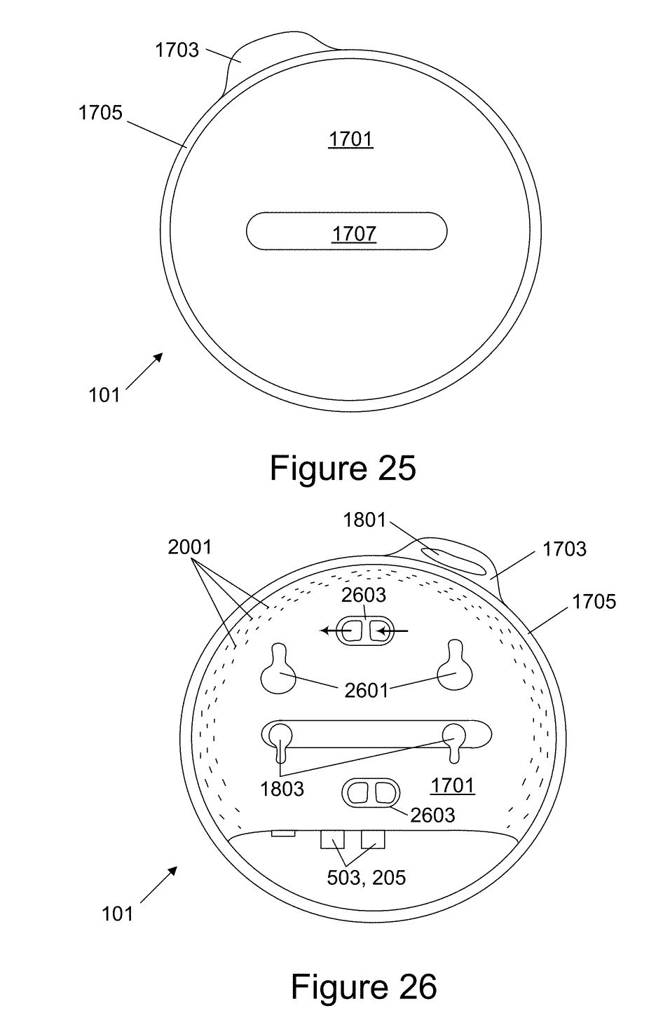

FIGS. 25 and 26 display another example embodiment of a media distributor. FIG. 25 displays a top view. The media distributor 101 may be in a circular housing 1701 that includes one or more tabs 1703 to affix a label or indicator to identify the display device whose audio is served through the labeled media distributor (one display device corresponds to one media distributor). In some embodiments, the housing 1701 may be made of plastic with a rubber edge 1705 to allow for easy handling and provide some impact protection. FIG. 26 displays a bottom view of the example media distributor 101. The housing may include attachment prongs 1803 to mount the media distributor 101 to a television, wall, or other surface. The media distributor 101 may include various audio inputs 205 and other connectors 503 described elsewhere herein. The housing may be cutout to allow access to the audio inputs 205. In some embodiments, the housing may extend along the top, past the audio inputs 205 to hide the audio inputs from view when the audio input device 101 is mounted to a display device. The housing may have head retaining holes 2601 for mounting the distributor by placing a screw or bolt head or the like in the large portion of the hole and then sliding the housing to move the head to a retained position with the smaller portion of the holes 2601 against a shaft of the screw or bolt. The housing may have tie retaining holes 2603 for mounting the distributor by placing a cable tie or a wire or the like in through one opening and then out through the adjacent opening and then around a fixture, as indicated by the arrows at the upper of the two tie retaining holes.

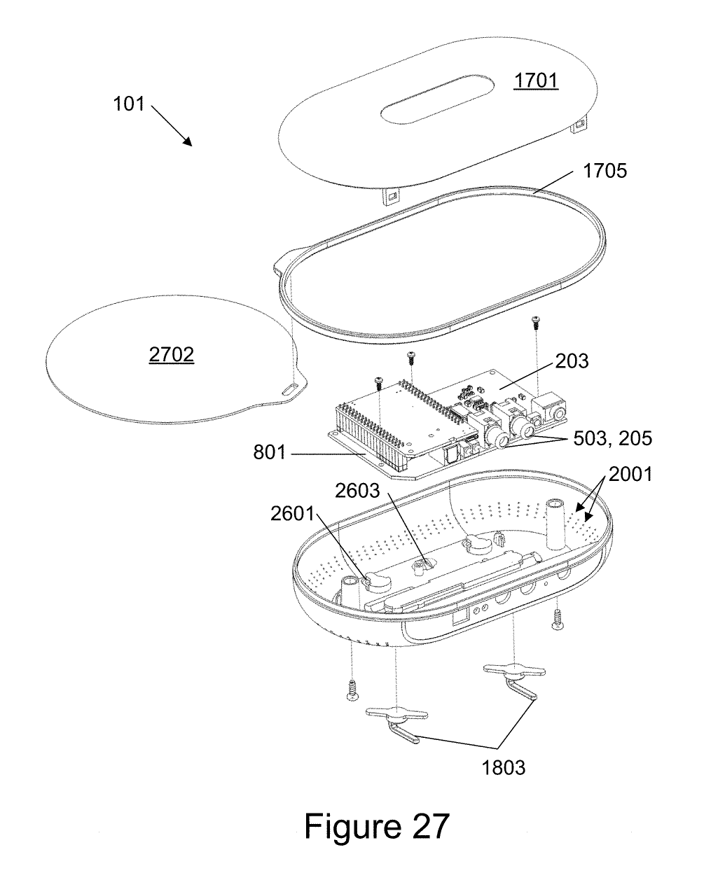

FIGS. 17 through 26 display example embodiments of a media distributor 101, with the understanding that various sizes and other features are also contemplated. For example, the media distributor 101 may be miniaturized to hide 3258 behind a display device 103, may be square or another shape, etc. The media distributor may include a board layout that includes a power supply, audio inputs 205, and various processing and other necessary electrical components. The board lay out may be stacked or miniaturized to reduce space, decrease noise, separate grounding planes, etc. For example, in a configuration not shown by FIG. 27, the media distributor may be the size of a USB drive and may be configured to connect directly to the display device 103. In further embodiments, portions of the media distributor 101 may be separate from the media distributor, such as a media distributor 101 that uses a processor, memory, etc. of a display device 101 such as a smart television, etc. For example, the media distributor 101 may be built and/or programmed into the components of the display device 103 as described elsewhere herein. FIGS. 8 and 26 show two different housing shapes, including an oval housing and a circle housing, to cover the components of the media distributor 101, while other embodiments are also contemplated.

FIG. 27 shows an exploded view of components of a media distributor 101 in one embodiment. As illustrated, a media distributor 101 may include a rubber ring 1705 that fits around the housing. In further embodiments, the ring may be made of a material other than rubber. The rubber ring may allow display indication labels 2702 to be affixed for a user to identify the name of the display device 103 as shown on the audio application 301. In some embodiments, the rubber ring and/or housing may be different colors. In further embodiments, the media distributor 101 may include holes 2601 or 2603 or both for mounting. The holes 2603 for mounting may receive loops (e.g., zipping ties) that may affix it to a post or other surface. In some embodiments, the holes 2601 may receive hook shapes 1803 that may be affixed to electronic devices.

The audio board 203 and various components may rest within the housing 1701 to be protected. The housing may be designed to minimize interference with the signals to and from the network 105. Components of the media distributor 101 displayed in FIG. 27 are also described in detail elsewhere herein.

Operating Environments

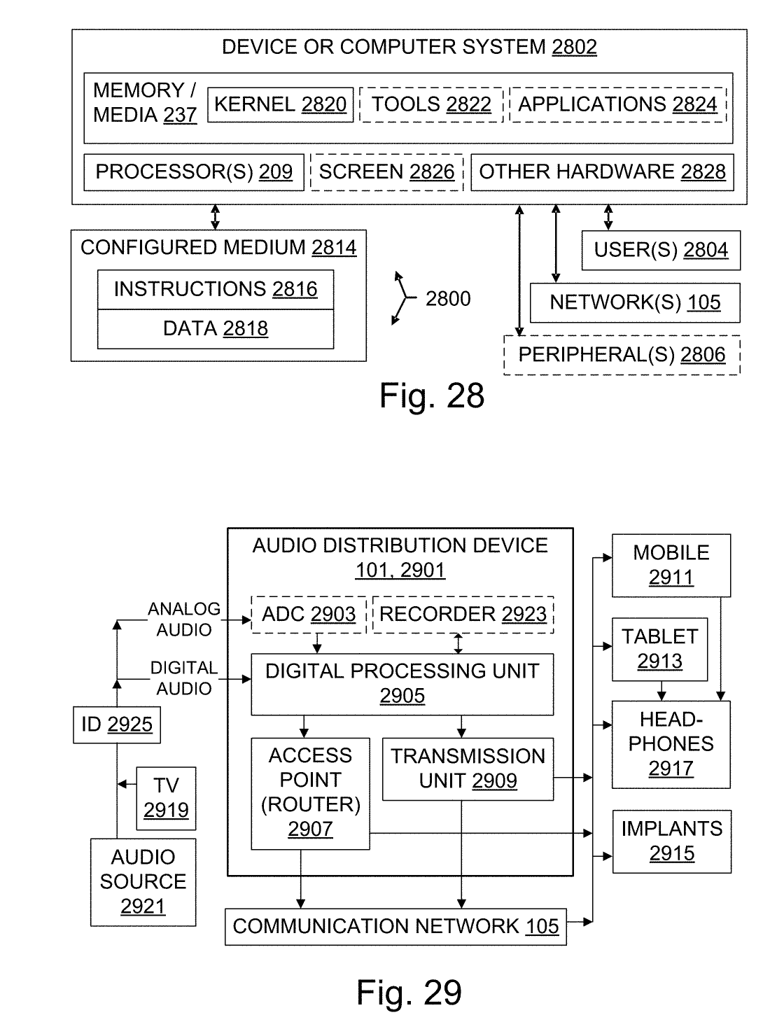

With reference to FIG. 28, an operating environment 2800 for an embodiment, also referred to as a cloud 2448 or distributed system 2800, includes at least two computer systems 2802 (one is shown). A given computer system 2802 may be a multiprocessor computer system, or not. An operating environment may include one or more machines in a given computer system, which may be clustered, client-server networked, and/or peer-to-peer networked within an operating environment 2800. An individual machine is a computer system, and a group of cooperating machines is also a computer system. A given computer system 2802 may be configured for end-users, e.g., with applications, for administrators, as a server, as a distributed processing node, and/or in other ways. Load balancing may be performed, using a mesh network or otherwise as described elsewhere herein.

Human users 2804 may interact with the computer system 2802 by using displays, keyboards, and other peripherals 2806, via typed text, touch, voice, movement, computer vision, gestures, and/or other forms of I/O. A user interface may support interaction between an embodiment and one or more human users. A user interface may include a command line interface, a graphical user interface (GUI), natural user interface (NUI), voice command interface, and/or other user interface (UI) presentations.

System administrators, developers, engineers, and end-users are each a particular type of user 2804. Automated agents, scripts, playback software, and the like acting on behalf of one or more people may also be users 2804. Storage devices and/or networking devices may be considered peripheral equipment in some embodiments and part or all of a system 2802 in other embodiments. Other computer systems not shown in FIG. 28 may interact in technological ways with the computer system 2802 or with another system embodiment using one or more connections to a network 105 via network interface equipment, for example.

Each computer system 2802 includes at least one logical processor 209. The computer system 2802, like other suitable systems, also includes one or more computer-readable storage media 237. Media 237 may be of different physical types. The media 237 may be volatile memory, non-volatile memory, fixed in place media, removable media, magnetic media, optical media, solid-state media, and/or of other types of physical durable storage media (as opposed to merely a propagated signal). In particular, a configured medium 2814 such as a portable (i.e., external) hard drive, CD, DVD, memory stick, or other removable non-volatile memory medium may become functionally a technological part of the computer system when inserted or otherwise installed, making its content accessible for interaction with and use by processor 209. The removable configured medium 2814 is an example of a computer-readable storage medium 237. Some other examples of computer-readable storage media 237 include built-in RAM, ROM, hard disks, and other memory storage devices which are not readily removable by users 2804. For compliance with current United States patent requirements, neither a computer-readable medium nor a computer-readable storage medium nor a computer-readable memory is a signal per se under any claim pending or granted in the United States.

The medium 2814 is configured with binary instructions 2816 that are executable by a processor 209; “executable” is used in a broad sense herein to include machine code, interpretable code, bytecode, and/or code that runs on a virtual machine, for example. The medium 2814 is also configured with data 2818 which is created, modified, referenced, and/or otherwise used for technical effect by execution of the instructions 2816. The instructions 2816 and the data 2818 configure the memory or other storage medium 2814 in which they reside; when that memory or other computer readable storage medium is a functional part of a given computer system, the instructions 2816 and data 2818 also configure that computer system. In some embodiments, a portion of the data 2818 is representative of real-world items such as conversations, musical performances, soundtracks, physical measurements, settings, images, readings, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 209 (CPUs, ALUs, FPUs, and/or GPUs), memory/storage media 237, an operating environment may also include other hardware 2828, such as displays, batteries, buses, power supplies, wired and wireless network interface cards, accelerators, racks, and network cables, for instance. A display may include one or more touch screens, screens responsive to input from a pen or tablet, or screens which operate solely for output, including without limitation virtual 2D or 3D screens such as those generated through holographic projection.

In some embodiments peripherals 2806 such as human user I/O devices (screen, keyboard, mouse, tablet, microphone, speaker, motion sensor, etc.) will be present in operable communication with one or more processors 209 and memory. However, an embodiment may also be deeply embedded in a technical system, such as a portion of the Internet of Things, such that no human user 2804 interacts directly with the embodiment. Software processes may be users 2804.

In some embodiments, the system includes multiple computers connected by a network 105. Networking interface equipment can provide access to networks 105, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches.

The one or more applications 2824, one or more kernels 2820, and other items shown in the Figures and/or discussed in the text, may each reside partially or entirely within one or more hardware media 237, thereby configuring those media for technical effects which go beyond the “normal” (i.e., least common denominator) interactions inherent in all hardware—software cooperative operation.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 28 is provided for convenience; inclusion of an item in FIG. 28 or any other Figure does not imply that the item, or the described use of the item, was known prior to the current innovations.

Examples are provided herein to help illustrate aspects of the technology, but the examples given within this document do not describe all of the possible embodiments. Embodiments are not limited to the specific implementations, arrangements, displays, features, approaches, or scenarios provided herein. A given embodiment may include additional or different technical features, mechanisms, sequences, or data structures, for instance, and may otherwise depart from the examples provided herein.

### Additional Examples

Some embodiments use or provide a system which includes a media distributor in operable wireless communication with a client device, e.g., smartphone, which itself includes a processor, display, audio output, and software that provides a connection to the media distributor, receives audio from the media distributor, and outputs audio to the user. In some embodiments, the system includes a media distributor in operable wireless communication with multiple client devices. Some embodiments also include a TV or another audio source. For convenience, “TV” as used herein includes both televisions which contain tuners, and flat panels or other displays that do not necessarily contain a tuner but which display signals sent to them from an externally located tuner. The tuner may be connected to cable, satellite dish, an aerial or other antenna, a digital video recorder (DVR), or another video source. Display devices are not limited to TVs, but also include devices which display content that did not originate through a tuner, such as internet-streamed content or content previously recorded which is being played back from storage. As also noted elsewhere, display device screens may be physical screens, e.g., LCD, OLED, or plasma screens, or virtual screens, e.g., holographically or other projected presentations.

Some embodiments do not include a client device as a separate intermediary between the media distributor and the audio output hardware. Instead, the media distributor communicates the audio directly and wirelessly to an audio output device such as headphones, ear buds, or an implant such as a wearable computing device or surgically implanted device, or an IoT device.

Some embodiments include a TV in which the media distributor is physically integrated (i.e., placed during TV manufacturing in the same outermost housing as the display screen or other visual display mechanism, a.k.a. “integral”), and is also electronically integrated (e.g., receives power from the TV's power supply, and also receives audio from the electronics within the TV housing without requiring the user to make that signal connection by plugging in a jack, and so on, a.k.a. “integral”). In some, the media distributor is also integrated in that the media distributor is not configured for repair by a consumer. In other embodiments, the media distributor is not physically integrated in the TV and instead gets physically mounted to the TV's housing by the person who owns the TV or manages operation of the TV.

Unless expressly stated otherwise, system embodiments do not include many-to-one connections from many TVs to a single shared media distributor. Avoiding the installation complexity, operational complexity, and expense of such many-TVs-to-one-distributor system architectures is an advantage of embodiments described herein. This includes hub-and-spoke system architectures with the distributor at the hub, for example, and other star topology architectures. In such architectures, one or more central devices receive serves as a distributor of the audio.

In some embodiments, the media distributor includes wireless network access point or router functionality; in others, it does not. Embodiments in which a media distributor includes an integrated wireless access point permit direct access to the media distributor by a client device, e.g., a user smartphone configured with an appropriate audio-only receiver. “Direct access” implies that a pre-existing wireless LAN is not required, although it may be present and be used for purposes other than providing audio content as taught herein. Some embodiments involve a wireless connection from the media distributor to a local wireless network, e.g., a business establishment network or a home wireless LAN network, through which the audio is transmitted to audio output devices such as a smartphone, earbuds connected to a smartphone, headphones connected to a smartphone, or WLAN-capable headphones connected directly to the wireless network. Other embodiments operate without the use of such a separable pre-existing local wireless network, e.g., by transmitting audio directly from the media distributor to an audio output device. Thus, depending on the embodiment, audio data may travel from a wireless access point of the media distributor through a wireless network to an audio output device such as a headphone (possibly via a smartphone), or instead audio data may travel from the media distributor directly to the headphones or other audio output device. This is illustrated by paths among those shown in FIG. 29.

FIG. 29 shows a block diagram of an audio distribution device 2901, also referred to herein as an “audio distributor”. Audio distributor 2901 is an example of a media distributor 101, tailored specifically for audio distribution, as opposed to the more general media distributor 101 which may distribute both audio and accompanying images in a video feed. As illustrated, audio information from an audio source 2921, such as a TV 2919, comes into the audio distributor. The audio information itself, or the audio source emitting it, or both, may have an associated identifier 2925 to distinguish the audio information from other audio information, e.g., as a separate channel, or as coming from a separate TV, or both. The audio information may be in analog or digital form. Analog audio information comes into an analog-to-digital converter 2903 and goes from there to a digital processing unit 2905, whereas digital audio information comes directly into the digital processing unit 2905. From the digital processing unit 2905, the audio information travels to a wireless access point 2907, or to a wireless transmission unit 2909 that does not operate as a local WLAN (wireless local area network) access point, or both. In some embodiments an access point that is located inside the distributor device can transmit directly to the client devices (smartphone, headphone, etc.), so a local pre-existing WLAN is not required. The distributor may use its own WLAN hardware such as Wi-Fi® hardware, or Bluetooth® hardware, or another transmission mechanism (Wi-Fi is a mark of Wi-Fi Alliance Corp., and Bluetooth is a mark of Bluetooth Special Interest Group). The audio information may then be transmitted to a recipient device, either directly or by way of a pre-existing local wireless communication network 105. The recipient device may have audio output hardware, e.g., as with headphones 2917 or implants 2915 such as hearing aids or cochlear implants or mobile computing devices when their speakers are used, or the recipient device may be an intermediary, such as a smartphone 2911 or tablet 2913 connected to ear buds or other headphones 2917.

Some embodiments have an audio signal input to an Analog to Digital Converter (ADC) or to digital processing unit, or both. A conversion module and analog audio receiver may serve as a digital processing unit. Some embodiments have options to eliminate the analog audio receiver (as indicated by dashed lines in FIG. 29) and go directly to the processed digital signal which does not have to be converted from the analog. Some may use an optical cable between the TV and the audio distributor, for example. Some systems in the future do not have an analog audio receiver.

After the audio information hits the digital processing unit it can go straight to a transmission unit and go through a direct communications protocol straight to user headphones or implants, for example, instead of going via a smartphone or tablet or laptop as an intermediary device. Audio information may also be transmitted to a virtual reality system, which for purposes of FIG. 21 may be considered either a mobile device or a headphone device, depending on its general-purpose computing power or lack thereof, respectively.

In some embodiments, audio information flows to a network router (part of the communication network 105) and then to one or more client devices 2911, 2913, 2915, 2917.

Some embodiments provide one or more advantages over some familiar systems that require multiple physically discrete hardware components that must be cabled or otherwise wired together, which is a system architecture characteristic that increases cost and user-perceived audio delays, and decreases user satisfaction. Some embodiments, such as some contemplated for commercialization under the inventor's CloviTek business, have all these audio information processing and transmission functionalities built in, thereby making them relatively easier use and easier to integrate into a home environment, or an enterprise environment. With a CloviTek™ audio distributor device, a user only needs a single device located at the TV (mark of CloviTek LLC). In some embodiments, such an audio distributor has functionality to transmit audio information to one or more client devices and also has functionality to receive audio information from the TV, with each of these functionalities implemented by logic (i.e., hardware and possibly also software) that is physically located within a single compact and lightweight device. As used herein, “compact and lightweight” means within the following dimensions: less than 0.25 kg in weight, exclusive of any cable or power cord; less than 600000 mm³. One compact and lightweight prototype CloviTek™ audio distributor device within these constraints weighs approximately 0.14 kg (0.3125 lbs) and has an outer housing with maximum dimensions of 38.1 mm (1.5″)×127 mm (5″)×101.6 mm (4″).

Some media distributors distribute video information, which includes both a sequence of images and audio information corresponding with those images. However, some embodiments are audio distributors, which either do not distribute video images at all, or else distribute only very limited video images (clips) that correspond to at most five percent of the audio information they distribute. Embodiments which focus on distributing audio without corresponding images run counter to trends favoring visual information in streams, e.g., website slide shows, web sites hosting user-uploaded videos, video accompanying or replacing textual news articles, and so on.

Various audio distributor use cases are contemplated as examples. User activities suitable for audio-only reception are broader than those commonly performed when viewing a video stream. Audio can be “associated” with moving images (video) even if those moving images are not currently being displayed. One can reliably and with satisfaction hear the audio while cooking, dressing, moving between rooms, and other residential activities. Some possibilities include home use and single user experiences. Other possibilities include business use, e.g., in bars or sporting venues, with multiple users.

In some embodiments, a given user can perform device activities such as program scheduling, listing available programs, and controlling the device through voice control.

In some embodiments, a given user can make 1613 a personal audio channel. In some, such a channel is available and visible only through use of an audio distributor of the kind described here. This limited availability may be implemented 1613, e.g., by embedding a unique identifier in the audio stream (e.g., via digitally certified metadata, or by modulation) that is only identified by the present audio distributor. An unusual radio frequency may also or alternately be used 1613 in transmitting the audio stream to create a personal channel 1615, namely, one that lies within the legally permitted frequency range for consumer devices but is distinguishable by a radio receiver from commonly used channels such as 2.4 GHz, 5 GHz, and 60 GHz. Some embodiments employ machine learning or an adaptive method to determine an optimal transmission channel.

Some embodiments integrate an audio distributor device into a television set. Such a TV may serve as a WLAN router, or may transmit audio directly to client devices. In some embodiments in which the TV has a wireless access point, an embodiment method includes the TV connecting to the client device, determining the audio desired, and transmitting the audio to the client device.

Some embodiments use or provide a method for reducing audio transmission delays. A software protocol may be used, similar to ping, to measure delay. Machine learning and adaptive feature software may be used to modify the delay compensation dynamically. One method includes 1) send an audio delay measure packet as custom packet data (audio time stamp at distributor, possibly from video time stamp if audio is separated off); 2) get time stamp at client device; 3) receive client timestamp back at audio distributor; 4) calculate the discrepancy in transmission delays for each leg (TV to distributor leg, and distributor to client device leg); 5) determine total delay; 6) pre-empt audio signal so that the device sends it early relative to corresponding video and thus the user experiences near-zero delay. One way to implement this involves controlling the TV's buffer content through software that interacts with the buffer. In cases where the integrated distributor device becomes an access point, that eliminates the hop from the TV to the audio distributor. TVs are only one example; other content-providing devices may also be built or configured to operate as taught herein to compensate for transmission delays when syncing remotely displayed video images with locally provided associated audio content. Some embodiments of the audio distributor transmit the audio early (relative to normal sync with corresponding video) using measurements of the various delays, so that the delayed but early-transmitted audio arrives at the client device in sync with the corresponding video, so far as the user's experience is concerned. To help accomplish this, some embodiments split the audio from the video, e.g., by using familiar audio extractor, audio converter, media converter, demultiplexer, or other technology.

Some embodiments split audio and video apart and then transmit only audio, no video. Some embodiments turn off the TV screen or other visual display mechanism and keep only audio running on the background. Some include a software apps where the audio continues to stream but the video doesn't. Some stop video processing and only process the audio. Some provide an alternative way of transmitting audio. Some embodiments accept user input and show a schedule diagram, and the user input specifies when to sleep the video, and then the system continues streaming audio after turning off the display.

Some embodiments use or provide a device that is accepts digital sound input and transmits directly audio only. The source of the digital sound input is not necessarily a TV, so the device can accept digital sound input from cable provider modems, for example.

Some embodiments support an audio distributor running in the background during otherwise normal use of a TV, to record audio from shows not being viewed, and store audio for a period, such as two weeks. Recent audio may also be recorded on a rolling basis, e.g., with the most recent 60 seconds of text available for playback. Then it is reformatted to a familiar podcast format to be played as a podcast. Some embodiments reformat stored (e.g., split or collected) audio as an audiobook, e.g., by automatically generating speech corresponding to the video program title and broadcast date. Speech may also be automatically generated from other metadata, including closed captioning metadata. Generated speech may be streamed in an approximately live manner (would be live but for processing and transmission delays), or it may be stored for later playback, or reformatted as an audiobook or podcast, for example.

Some embodiments use or provide an audio streaming box, with no images or TV video streamed; only audio transmissions reach the user. Some carry audio information from one or more audio inputs to the digital processing unit. In some cases, that digital processing unit can separate out or otherwise extract audio and forward only audio information. Whether extracted or not extracted, audio information can go to users directly or via intermediary devices, and may be sent toward users contemporaneously or later from a recorder or other storage.

Some systems receive a typical TV stream and then transmit both the audio and video data. In some, a user can get most or all the features of the TV, e.g., the user can store shows, record them, and view associated metadata such as titles, summaries, broadcast dates, broadcast stations, and durations. In some embodiments, a user can replay a show as an audio book. The audio book or podcast options may be appreciated in particular by users who are unable or unwilling to watch shows in a typical manner but instead receive the audio while driving or commuting.

Some embodiments can receive all types of signals but only stream audio. With some, a user can create saved audio files, and put them into storage via the TV's user interface, and can save those files as audio books and podcasts out of a video source, such as TV show. In some embodiments, recorded audio stored in the cloud or on a client device or in a distributor or a display device may be replayed. Such replay may be controlled via the client device, via the display device, or via the distributor, for example.

As used herein, “wireless” includes, e.g., Wi-Fi®, Bluetooth®, FM radio, radio frequency (RF), infrared, laser, cellular (CDMA, GSM, LTE, etc.), and other technological data transmission mechanisms and methods that do not rely primarily on the use of metal wires or fiber optic connections for signal transmission.

Some devices cap the number of simultaneous connections to an audio distributer at 56, or a nearby number such as 50, 54, 58, or 60, because if more connections introduced, the quality is reduced and undesired latency is introduced. Load balancing may be performed, to increase or overcome such caps, using a mesh network or otherwise as described elsewhere herein.

Some embodiments are limited to audio-only connections, and omit the hardware and software that supports full video connections in familiar devices. Some embodiments only support audio transmission to a mobile device, rather than transmission of TV video to the mobile device. There are technical differences beyond the mere omission of images. With a video connection the sound and the video are presented to the user at the same location, but with audio-only connection there might be associated video presented at a remote TV or other remote screen or by holographic projection, so audio and video synchronization becomes a challenge. One use case is a user who sits in a big stadium arena and wants to hear announcements. With only conventional options, it is hard to hear through all the screaming around, but with an embodiment the user could listen through a mobile device and headphones to hear the announcements transmitted from an audio distributor. As another example, assume a user in a coffee shop wants to be aurally isolated from the surrounding noisy environment. The user can connect headphones to a mobile device which will be connected through a WLAN to the hardware that would transmit audio, in order to listen to music without any environmental noises.

More generally, moving images (video) may be experienced independently of associated audio, and vice versa, according to teachings and some embodiments described herein. One may stream only the video through distributors and client devices in situations where audio is already heard and understood by users at their client devices, e.g., when an announcer is heard but a corresponding display screen is not currently visible, such as at many locations in arenas, churches, conference centers, stadiums, or other large event venues. Conversely, one may stream only the audio, regardless of whether the video images are visible.

Some use cases are targeted to businesses, and others to homes. In some cases, a consumer application provides each consumer an ability to listen to TVs at home. If a consumer has two or more TVs turned on simultaneously, whichever TV-audio-distributor pair is closer (in terms of signal strength, or latency, or a mix of the two) to the mobile device will automatically pick up the signal and transmit audio to the mobile phone. Algorithms used for cell phone tower roaming can be adapted to the smaller scale of a home or even a business location. Some embodiments offer a manual switching option for switching 1601 between audio sources.

Automatic Updates

In some embodiments, a special agent on the access point will periodically request updates from an update server. If there is a new version of the audio distributor software (including firmware), then it loads the archive with the update. The update archive includes all firmware files and their checksums, which are checked after downloading and unpacking (the archive checksum is also checked). The new firmware is deployed in parallel with the current version, all current settings are copied to it, basic functionality tests such as a power-on-selftest are made. If everything is installed successfully, then the firmware download switches to the current version. At the time of installing the firmware it may be desirable for the point to go into a maintenance mode. In this mode it is desirable (but not necessary) to stop the broadcast, and the system informs the user that the point is in maintenance mode. The maintenance mode alert can be sound, can be displayed on the application screen, or both. Kernel software and server software may also be automatically updated.

Configuration

Remote point configuration (remotely connect to each broadcasting point, perform service and upgrade) may be provided as part of automatic update functionality. In some embodiments, web-based administration is enabled for remote configuration, allowing administrators to do management through a web interface. This may be implemented in various wasy, including for example through an adaptation of the familiar Ansible configuration management tools. To connect to points, SSH or SSL tunnels will be used, which will automatically be raised between an audio distributor and a configuration server.

Some embodiments support or use banner ads or other advertising or both. They may obtain content from a wide advertising network for the distribution of promotional materials. Possibilities may include advertising on personal devices, and advertising on business users' devices. The format of advertising may include a photo banner in advance of a coordinated size or a video clip, e.g. a 10 second clip. Additional options may include audio advertising for example at the time of a broadcast.

Some systems include a base of public audio distributors. This approach may benefit large customers. The audio distributors may be presented as access points, through navigation on the map for instance. As a use case, suppose a user comes to a public place, e.g., a bar, restaurant, fitness hall, airport, or the like. The user launches the application to find the nearest audio distributor device. The user sees the nearby devices, with additional information detailing where they are (floor, place names, etc.), how to connect to them (e.g., local WLAN password), their name on the network, and what they are currently broadcasting, for example. In some embodiments, using GPS the coordinates of points will be set at the point setup in a personal profile or cabinet. In some, the audio distributor includes a GPS sensor, and the audio distributor's location is registered automatically with the smartphone app.

In some embodiments, a local pre-existing wireless network is not required to receive audio from the audio distributor. Instead, or as an alternate to a pre-existing wireless network, the audio distributor may raise its own WLAN for connection. This can improve the signal quality and the user's overall experience, when the purpose of the entire system is listening only, and not even browsing. Firstly, a user or administrator need not manually set up and connect the audio distributor to a general-purpose WLAN. Secondly, audio transmission is not dependent on the client's router and the quality of its WLAN. This approach also does not divide the Internet channel and the router with third-party devices and programs, so the audio distributor can more precisely control the traffic from it and more fully optimize the WLAN for that task.

Some embodiments include a special section in an application menu, where a user can post sample questions and answers. Editing and managing the list of questions will be available in the admin panel on the backend side. The list of questions and answers will be downloaded from there dynamically. If the user has not found the answer to a question, the user can send it through a special application form, which will be sent to customer support. In some embodiments, the user may obtain answers, technical examples, instructions, troubleshooting help, and other assistance through a chatbot, wizard, artificial intelligence subsystem, or other virtual assistant.

Some embodiments use or provide audio distributor transmission to Bluetooth devices, such as to personal headphones, a virtual reality headset, or Bluetooth to FDA-approved digital medical devices such as hearing aids.

In some embodiments, scheduling of program recording occurs automatically when a TV is turned on and the client device app is running. The audio application may receive television show schedules and provide them for display on the client device. A list of television shows can be captured and displayed to a user such that a user can schedule reminders. These reminders may be synced with various calendar applications on the client device and record those television shows on the client device, if the sound transmitter device and the audio application are operating together.

Some embodiments sync with other devices, e.g., a smart lamp that would change colors or set the mood.

Some embodiments support social media login or simple email login and user profile management on the client device. This will also sync with the centralized cloud service.

With some embodiments, analytics data is available to enhance user experiences and build successful targeted marketing campaigns based on the user experiences.

Some embodiments make recommendations through RSS feeds based on the user habits (watching TV trends).

Some embodiments coordinate with a ticketing support system with CRM system and device management.

Some embodiments use or provide port management. For example, some businesses allow communications only through specific open ports.

Some embodiments make a Dolby® option available to a customer if they purchase an additional license for this option. Dolby-equipped TVs may include or connect to audio distributors that are able to transmit Dolby sound. Some of headphones also surround sound.

Some embodiments provide or utilize an advantage of wireless technology, namely, the lack of a physical cable or wire and the possibility of extended coverage beyond one room.

Some embodiments use or provide one of more of the following differentiation by value characteristics.

Device Compactness.

The size of one prototype audio distributor product make the product compact enough for users to be able to place it on a TV or hide it behind the TV. A familiar somewhat competing device size is about (H×W×D) 45 mm (1.75″)×4,283 mm (19″)×286 mm (11.25″) (excludes feet) and weighs about 34.5 kg (10 lbs). The prototype audio distributor device's dimensions are 38.1 mm (1.5″)×127 mm (5″)×101.6 mm (4″) and it weighs only 0.14 kg (0.3125 lbs).

Affordability.

In some familiar architectures, different television audio feeds are wired to a sound system transmitter configured to broadcast wireless audio that listeners can receive privately through their mobile device. However, while these complex audio transmitters provide wireless audio to some extent, the complex audio transmitters are expensive and require complex audio wiring to connect the various televisions to the audio transmitters. This complex wiring makes these types of systems cost prohibitive everywhere except large public venues such as gyms and bars. The prototype audio distributor device's target $120 retail price is attractive compared to potential competitors' prices which may range from $600 to $10,000 per unit and in some cases require subscription and installation fees not required for embodiments described here.

Functionality/Features.

The client device app taught herein may be implemented to have additional features that are not present in the potential competitors' apps. For example, the embodiment app may schedule future programs, show reminders, or even start recording the audio streaming to the phone, if the TV is turned on. Some embodiments allow users to choose the technology they want to use in their homes, such as Bluetooth if users do not have a wireless network setup, or Wi-Fi technology, unlike potential competition that offers only Wi-Fi transmission to users.

Ease of Use.

The embodiment's product and service is easy to use and requires minimal instruction. Teachings herein give multiple ways to mount the audio distributor device behind or by the TV with adjustable mounting options. Potential competitor products require a large physical space for server installation and require wiring of each TV to their audio rack. These services cost money and require expertise. Consumers at home or small business owners often cannot afford such services. An CloviFi™ audio distributor prototype device is so simple that it can be installed in simple steps, such as in the following example:

1. Connect the device to the TV via one of multiple optional audio inputs.
2. Connect a mobile phone or any other mobile device with the CloviFi device via BlueTooth or an existing Wi-Fi network.
3. Download, install, and run a CloviFi mobile app on the mobile device (will be available for iOS and Android platforms).
4. Chose from the list of available TVs in the app and start listening through headphones connected to the mobile device.

Transmission Quality.

With Bluetooth audio transmission, potential competitors' systems are limited by the capabilities of Bluetooth, which only allows limited device connectivity, has a limited range, and limited data transmission capabilities. Other systems based on IR (Infrared, typically operate in the 2-4 MHz band) and RF (radio frequency, typically operate in the 40-90 MHz band (VHF) or 800-900 MHz band (UHF)) wireless technology are more susceptible to interference issues and have a low ability to penetrate obstacles in comparison to the Wi-Fi technology-based systems. The CloviFi™ audio distributor device (mark of CloviTek LLC) has Wi-Fi technology, which has a greater range than Bluetooth, and there is little or no loss of audio fidelity as the data signal travels across the Wi-Fi network.

Connectivity.

Potential competition offers only stereo phono (RCA) or, in some instances, a 3.5-mm audio jack connectivity method. By contrast, CloviFi devices may offer multiple ways to connect to their audio source, e.g., stereo phono (RCA), 3.5 mm audio jack, Bluetooth, SPDIF optical (TOSLINK) or other optical, and HDMI ARC or other HDMI. Some embodiments provide or use audio transmission with a sound delay under 100 ms, a 48 kHz frequency response, and 16 bit resolution.

FIGS. 30-33 individually and collectively illustrate some process embodiments in flowcharts 3000, 3100, 3200, 3300. Technical processes shown in the Figures or otherwise disclosed will be performed automatically, e.g., by audio distributor or user client device application code, unless otherwise expressly indicated. Processes may be performed in part automatically and in part manually to the extent action by a human administrator, end-user, or other human person is implicated. No process contemplated as innovative herein is entirely manual. In a given embodiment zero or more illustrated steps of a process may be repeated, perhaps with different parameters or data to operate on. Steps in an embodiment may also be done in a different order than the top-to-bottom order that is laid out in FIGS. 30-33. Steps may be performed serially, in a partially overlapping manner, or fully in parallel. The order in which one or more of the flowcharts shown in FIGS. 30-33 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Configured Media

Some embodiments include a configured computer-readable storage medium. Medium may include disks (magnetic, optical, or otherwise), RAM, EEPROMS or other ROMs, and/or other configurable memory, including in particular computer-readable media (which are not mere propagated signals). The storage medium which is configured may be in particular a removable storage medium such as a CD, DVD, or flash memory. A general-purpose memory, which may be removable or not, and may be volatile or not, can be configured into an embodiment using items such as audio source identifiers, recorded audio, and client device application code, in the form of data and instructions, read from a removable medium and/or another source such as a network connection, to form a configured medium. The configured medium is capable of causing a computer system to perform technical process steps for reallocating scarce capacity as disclosed herein. The Figures thus help illustrate configured storage media embodiments and process embodiments, as well as system and process embodiments. In particular, any of the process steps illustrated in FIG. 4 or FIGS. 30-33 or otherwise taught herein, may be used to help configure a storage medium to form a configured medium embodiment.

In some embodiments, the audio distributor can include API communications and interactions with third party applications/devices, e.g., on mobile phones where some applications allow a smartphone to provide a natural language translation or another result that it cannot provide on its own. External products such as Blackfire® products may be used to improve sound transmission over wireless media (mark of Blackfire Research Corp.). Another example is Dolby® sound software (mark of Dolby Laboratories Licensing Corp.).

Some embodiments support connection directly to headphones via Bluetooth. Some support similar direct connections via other wireless methods (radio waves, Wi-Fi) from any audio source to the headphones or hearing aids, or anything else that allows a user to listen to audio.

Some current devices such as iPhone or Android have voice control capabilities. Similar existing platforms and APIs provide voice control command capabilities to some audio distributor or client device application embodiments.

Some embodiments include self-adapting algorithms in an audio distributor device, which adapt sound transmission quality based on the environmental parameters where the device is used, e.g., home setting vs club or bar. Delays and sound quality may be much different in different settings.

Some embodiments utilize speech-to-text or closed caption functionality. Some display text with the corresponding sound on the mobile devices. In some, the text can be converted into ebooks for reading again. For example, some use or provide dictation service apps that convert voice from human speech into text with punctuation. Some embodiments have text recording capabilities, e.g., to record text from movies, for example. Then that text can be converted into eBook format and stored in cloud based book libraries.

Some embodiments transmit sound over a WLAN. Some use light as a sound transmitter, so there is no need to use a WLAN router. Some use electrical wires in the wall to transmit signals.

Some embodiments use or provide one or more of the following features:

### Add Wi-Fi and Bluetooth to Audio Devices

Stream Music Wirelessly from TV or other Audio Sources
Stream to your Smartphone or Directly to your Headphones

### 24 bit Premium High Quality Sound

### Connect Through Various Audio Inputs

### Free Android and iOS App

Multiple Adjustable Mounting Options for your TV
Control your own sound level without bothering others
Select between multiple CloviFi devices located in different rooms
Connect several listeners in the same room to the same TV at once
Use your own headphones
Use existing Wi-Fi network for streaming, or stream directly to the client device from a media distributor as an access point

Load Balancing

Some embodiments use or provide one or more load balancing features. Some support or provide or use a load balancing setup for scalable audio distribution.

Sometimes the required capacity of a particular audio distribution system configuration is too large in practice for that configuration, e.g., when the system can handle twenty connections but it gets five more new connections—totaling twenty-five simultaneous connections. Imagine sending all requests to any widely used application to a single server; the overload may cause the system to slow down, to reject new connections, or to even go completely down. A load balancing process spreads the requests into separate servers. For this reason, it is important to consider scalability of the system through load balancing and high availability which may increase reliability and availability of the system to the consumer.

In some embodiments, distribution devices 101 will be interconnected to each other to provide a mesh network between all distribution units, allowing load balancing and moving excessive load from one device to other devices on the same mesh network to allow more mobile devices to connect to any given audio broadcast. FIG. 34 illustrates one mesh network 3400 example. This mesh network between devices could be created to piggy-back off of a wireless local area network (WLAN) or as a totally independent audio FM radio signal mesh network, with each node spreading the radio signal or other wireless signal a little further than the last. The purpose of creating a mesh network through multiple load balancer devices 3404 is to share and balance the amount of users connected to a single distributor device 101 at the same time, thus preserving the quality of the audio signal, and preserving the reliability, predictability, and functionality of devices. Load balancing may prevent any single device from being overloaded by too many people wanting to connect and listen to the audio broadcast from a single source and thus degrading the audio signal from overload.

Load balancing is a process of spreading a system's load over multiple machines.

FIG. 34 illustrates a load balancing architecture. Media distributors 101 are connected to, or integrated within, one or more display devices 103. A load balanced system 3402 may include one or more devices interconnected wirelessly or via wires or by a hardware platform. If a given TV has only one CloviFi (for example) device and another TV on the same network is sitting idle with a low number of connections, then the idle (or merely underutilized) TV can send status to the first TV distributor, which will route traffic (e.g., audio) to the underutilized or idle TV distributor. Two or more CloviFi (for example) devices can be attached to a given TV or other display device or embedded therein. Such devices may be implemented partially or primarily in software, e.g., as drivers or embedded handlers.

Status messaging and load sharing may be implemented by load balancer 3404 hardware and/or software, e.g., using a method to form an array 3410 of balanced devices via hardware or protocol or software. In the illustrated configuration in FIG. 34, a leader CloviFi (for example) device 3406 identified here for convenience as Leader 1 (which may be a suitably configured distributor 101) routes traffic to a follower device 3408 identified here for convenience as Follower 2. Another leader 3406, identified in the Figure as Leader 3, likewise routes traffic to one or more followers. The Leaders also provide status information to one another, as indicated by the link shown between them in FIG. 34. The leaders may continually ping each other to provide status of connected follower devices, e.g., whether they are online, and whether they are overloaded. Traffic may travel via audio transmission protocols, wirelessly, or by wire. The leader/follower roles may be alternately identified in some implementations as master/slave roles.

In some embodiments, load balancer 3404 hardware allows each individual device to spread the requests around to different devices in the system. A minimum of two distributor devices are present to benefit from a clustering approach of which one system could serve as the cluster manager (including serving as a load balancing router) for all other connected CloviFi devices on the same or separate networks. In the audio distribution system, the system can have a load balancer and still not be highly available. It may be scalable but not be online. Some configurations implement the load balancing system with a high availability feature. A network load balancing feature can be installed on every CloviFi device to create a NLB (network load balancing) cluster. The first client will be directed to the first server, the second client to the second, and so on. Clients are concerned about connection to the system. However, if one server fails, then two other servers would be able to handle the connections. One can add more CloviFi devices(for example) to handle more connections to scale for higher connectivity request handling. Although CloviFi devices are used in these example discussions, devices with similar functionality but sold or leased under other marks may also be used.

How it Works. As a specific example, a first CloviFi device (node) Leader 1 will have the max amount (higher weight) of connections. When the first twenty connections are connected then the twenty-first connection will go to server Follower 2. Each connected system will have assigned weighted numbers for subsequent connections. If one server gets overloaded faster than the other then (for example the amount of clients connected to the same device and stay connected while the second device keeps getting new connections), then the client will determine which devices have the least connections, and then the load balancer will assign new connections to the server with the least connections. Weighted least connections will have specified highest weighted number to the audio distributed system 1 and then lowest number to the second system and so on.

Each CloviFi system can be either connected via host (HTTP/S protocol, Zigbee, Wi-Fi®, 5G network—or any other network—or its own audio protocol that is utilized by the audio system only for audio transmission, etc.) or on the hardware level (e.g., by wires) or share the same hardware for processing the requests. Hardware to get requests and deliver the processed audio signal could be placed in separate systems. If one assigns to System 1 higher weighted number, say 10, and to System 2 the number 9, and to system 3, the number 8, and so on, then one would utilize the system with the highest number first and then move to the next system. But sometimes a configuration may use a randomizing algorithm for connection processing. It may choose one or another way to connect randomly and evenly distribute connections to the servers. The system with the lowest number of connections will always be the first to allow connection, whereas the system with the highest number of connections, will pass those connections to the system with the lowest number of connections. This does not necessarily mean that System 1 will pass connections to System 2 because it has the next highest weighed number; it may have enough information about System 3 and 2 to pass the connections to the system 3 because system 3 has the lowest number of connections.

High Availability. If one of the system components go down, it won't necessarily bring the entire system down. Some embodiments have the ability to instantly redirect access if the backup system component fails. In the Audio Distribution system, two or more audio systems A and B can be interconnected. While system B may be an identical copy of system A, system B is utilized until either one of two things happen: system A goes down, or system A gets overloaded. System B is offline and constantly monitors system A. If System A is down then System B will activate and requests will go to System B. Users will not know that System A is down.

Additional Considerations

Some embodiments provide or use direct-to-peripheral connections from a media distributor to a peripheral such as headphones, hearing aids, implants, etc. In some cases, additional digital processing is performed when the peripheral uses a proprietary communication standard, to avoid picking up external noise, or provide higher security, or both.

In some embodiments, in which a media distributor has an integrated internal wireless router, processor communication methods provide the capability of switching between the access point, cloud network distribution, direct wireless, direct BLE (BlueTooth Low Energy), and/or other transmission methods. In some, media distribution as taught herein is integrated into a TV, and in some, it is integrated into other systems such as an audio only streaming device, or a set-top box capable of receiving any signal including video that nonetheless streams audio. Signals can include cable, digital, over-the-air, PC (gaming consoles may be considered PCs in this regard), any analog/digital signal, and/or radio/audio only, to external devices that output audio: speakers, “home” controllers (Alexa, Google Home, Apple Home; marks of their respective owners).

Some embodiments can record video/audio such that a generated audiobook/podcast/etc. can be immediately sent to user (while recording) or can be saved in these formats such that a user can listen to shows/audiobooks/etc. later on their spare time, such as on their commute. This typically involves splitting video/audio during processing.

In some cases, video viewing is not necessary to utilize the audio processes herein. For example, a user may be in another room than the display, may be paying less or no attention to visual images while cooking, may be getting ready for work, etc., while the audio is present and transmitted as taught herein. In some cases, user client device controls can visually mute main media to turn off a display while continuing to process and transmit audio. A sleep mode may be implemented with only audio transmitted, while disabling video processing, therefore saving power.

Some embodiments use or provide a method to determine and compensate for audio delays at a media distributor and/or client device. Some preempt an audio source; this may be implemented with logic built into any audio device or logic that has access to a media buffer. Some transmit audio “early” such that a user hears it with no perceptible transmission delay because the visual images and audio reach the user at the same time, or what appears to the user to be the same time. Some use machine learning to adapt to user and location conditions. Some use custom delay packets to gather or transmit delay data based on video.time, audio.time, transmit.time, received.time, etc. Some determine discrepancies and adjust to best suit the user, compensating for delays due to processing, transmission, encoding, access point channel changes, etc. Some use data from an RSSI (radio signal strength indicator) or make phase adjustments or both. Some compensate for delays across a transmission path that includes a media distributor device, an audio device (e.g., TV), a user phone (including app software), and user peripherals (e.g., wireless headphones).

Some Additional Combinations and Variations

Any combinations of code, data structures, logic, components, communications, and/or their functional equivalents may be combined with any of the systems and their variations described herein. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the medium combinations and variants describe above.

### CONCLUSION

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Moreover, directional and positional phrases, such as “upper”, “lower”, “lateral”, “bottom”, “top”, “front”, “rear”, “downwardly”, “upwardly”, “laterally”, “axially”, etc., are used herein for illustration purposes only and should not be construed as limiting the scope of the present invention.

The disclosure need not be limited to the disclosed embodiments. It is intended to cover various modifications and similar arrangements included within the spirit and scope of the claim(s), the scope of which should be accorded the broadest interpretation so as to encompass all such modifications and similar structures. The present disclosure includes any and all embodiments of the following claim(s).

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout this disclosure, any discussions using terms that include “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor, coupled directly or indirectly to memory elements through a system bus. The memory elements can include local memory employed during execution of the program code, bulk storage, and cache memories that provide temporary storage of at least some program code to reduce the number of times code must be retrieved from bulk storage during execution. Input/output (I/O) devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless transceivers, Ethernet adapters, and modems, are just a few examples of network adapters. The private and public networks may have any number of configurations and/or topologies. Data may be transmitted between these devices via the networks, using a variety of different communication protocols including, for example, various Internet-layer, transport-layer, or application-layer protocols. For example, data may be transmitted via the networks, using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct a more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

### Additional Examples

### Example 1

A method of providing a wireless distributed audio feed using a media distributor including: receiving at the media distributor, which is coupled to a display device, an audio feed related to video content; identifying a first client device from a plurality of client devices wirelessly connected to the media distributor via a wireless network, the media distributor having previously received a request from the first client device to access the audio feed over the network; sending the audio feed to the first client device via the wireless network; and performing at least one of the following tailoring steps: facilitating the request to access the audio feed by providing prior to the request a non-digital visual identifier of the display device within one foot of the display device which non-electronically visually identifies the display device as a source of the audio feed; facilitating the request to access the audio feed by providing display device location data or media distributor signal strength data or video content metadata or audio feed metadata or a combination thereof to the first client device prior to the request; supporting the sending of the audio feed by load balancing at least a portion of the audio feed using at least one additional media distributor; or supporting the sending of the audio feed by syncing an arrival of the audio feed at the first client device with a presentation of corresponding video content on the display device based on a measured or estimated time for the audio feed to travel from the display device to the first client device.

### Example 2

The method of Example 1, including at least two of the listed tailoring steps.

### Example 3

The method of Example 1, wherein sending the audio feed includes using a personal audio channel which is personal to the first client device.

### Example 4

The method of Example 1, further including splitting audio from the video content and then transmitting at least a portion of resulting audio when sending the audio feed.

### Example 5

The method of Example 1, wherein sending the audio feed includes multicasting.

### Example 6

A computer-readable storage medium configured with executable instructions to perform a method of providing a wireless distributed audio feed using a media distributor, the method including: receiving at the media distributor coupled to a display device, an audio feed related to video content from the display device presenting the video content; identifying a first client device from a plurality of client devices wirelessly connected to the media distributor via a wireless network, the media distributor having previously received a request to access the audio feed over the network from the first client device; sending the audio feed to the first client device via the wireless network; and facilitating the request to access the audio feed by providing display device location data or media distributor signal strength data or video content metadata or audio feed metadata or a combination thereof to the first client device prior to the request.

### Example 7

A system including: a media distributor configured to be coupled to a display device, the media distributor having circuitry with a processor, the circuitry configured to synchronize an arrival of an audio feed at a client device with a presentation of corresponding video content on the display device based on a measured or estimated delay time for the audio feed to travel from the display device to the client device, and configured to send the synchronized audio feed from the media distributor toward the client device.

### Example 8

The system of Example 7, including the media distributor and the display device coupled to one another.

### Example 9

The system of Example 7, including the media distributor and the client device in communication with one another, wherein the client device is configured with at least one of the following features: logic for automatically switching between media distributors, logic for setting reminders of video content, or logic for recording audio content sent from the media distributor, wherein logic includes hardware and software.

### Example 10

The system of Example 7, wherein the media distributor has a universal serial bus port for connecting to the display device.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

Although particular embodiments are expressly illustrated and described herein as processes, as configured media, or as systems, it will be appreciated that discussion of one type of embodiment also generally extends to other embodiment types. For instance, the descriptions of processes in connection with FIG. 4 and FIGS. 30-33 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific APIs, specific fields, and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 209 may process 209 instructions by executing them.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A display device comprising:
a housing;
a video content input mounted in the housing;
a display mechanism mounted in the housing, the display mechanism in operable communication with the video content source;
a media distributor, the media distributor being integrated in the display device in that the media distributor is mounted inside the housing, the media distributor including an audio board with a processor, the media distributor also including a wireless access point;
the display device being configured to split audio content from video images in video content received through the video content input and configured to send the audio content wirelessly over a network to a client device without sending the corresponding video images over the network to the client device.

2. The display device of claim 1, wherein the video content input includes or is in operable communication with at least one of the following: a tuner, an HDMI connector, a USB connector, an optical cable connector, a composite video connector, an S-Video connector, a coaxial cable connector.

3. The display device of claim 1, wherein the display mechanism includes at least one of the following: an LCD display, an OLED display, a plasma display, a projector with a light source.

4. The display device of claim 1, wherein the wireless access point is configured to operate in conformance with at least one of the following: an IEEE 802.11 wireless communication method, an IEEE 802.16 wireless communication method, or a Bluetooth wireless communication method.

5. The display device of claim 1, wherein the wireless access point is configured to perform multicasting of the audio content.

6. The display device of claim 1, wherein the display device is configured to synchronize an arrival of an audio feed at a client device with a presentation of corresponding video content on the display based on a measured or estimated delay time for the audio feed to travel from the display device to the client device.

7. The display device of claim 1, wherein the display device is configured to do at least one of the following: recognize a personal audio channel and to send the audio content on the personal audio channel, convert analog data to obtain digital audio content and send the digital audio content wirelessly toward a client device.

8. The display device of claim 1, wherein the media distributor is configured to perform load balancing of at least a portion of the audio content.

9. The display device of claim 1, wherein the media distributor is also integrated in that the media distributor and the display are both fed using power which first comes into the display device though a power plug of the display device.

10. A method of providing a wireless distributed audio feed using a media distributor comprising:
receiving at the media distributor coupled to a display device, an audio feed related to video content from the display device presenting the video content;
identifying a first client device from a plurality of client devices wirelessly connected to the media distributor via a wireless network, the media distributor having previously received a request to access the audio feed over the network from the first client device;
sending the audio feed without the corresponding video content to the first client device via the wireless network; and
providing a visual identifier of the display device within one foot of the display device which visually identifies the display device to the client device or to a user of the client device as a source of the audio feed.

11. The method of claim 10, wherein the visual identifier includes a video frame captured from the video content, which distinguishes the display device from at least one other device that is displaying different video content that lacks the captured video frame.

12. The method of claim 10, wherein the visual identifier includes a label attached to the media distributor, and the label and the media distributor are each located within one foot of the display device.

13. A method of obtaining an audio feed at a client device, the method comprising:
selecting a distributor which is coupled to a display device; and
receiving wirelessly at the client device an audio-only signal from the selected distributor, the audio-only signal being an audio portion of video content which is displayed on a display device, the display device corresponding in a one-to-one manner with the selected distributor, the audio-only signal being audible at the client device via the client device as opposed to being audible at the client device via speakers in the display device, an images-sequence video portion of the video content being visible on the display device from the location of the client device, the client device location being at least ten feet from the display device.

14. The method of claim 13, wherein the selecting selects the distributor based on user input to the client device.

15. The method of claim 13, wherein the selecting selects the distributor automatically based on one or more of the following: a trend analysis of past selections, a reminder set to select a distributor based on particular video content, a signal strength of a wireless transmission of the audio-only content.

16. The method of claim 13, wherein the receiving receives the audio-only content wirelessly at a smartphone client device which is at least fifteen feet from the display device.

17. The method of claim 13, further comprising recording on the client device at least a portion of the received audio-only content.

18. The method of claim 13, wherein the method comprises capturing a video frame from the video content, displaying a thumbnail or portion of the captured video frame on the client device, and selecting the distributor in response to a user selecting the displayed thumbnail or portion as an identifier of the distributor.

19. The method of claim 13, further comprising treating at least a portion of the received audio-only content as a podcast or as an audiobook.

20. The method of claim 13, further comprising automatically generating at least a portion of the received audio-only content from a closed captioning of the video content.
